(19) United States
(12) Patent Application Publication
(10) Pub. No.: US 2015/0286802 A1
(43) Pub. Date: Oct. 8, 2015

(54) SYSTEM AND METHOD FOR CLINICAL TRIAL MANAGEMENT

(71) Applicant: Himanshu Kansara, Santa Clara, CA (US)

(72) Inventor: Himanshu Kansara, Santa Clara, CA (US)

(21) Appl. No.: 14/680,597

(22) Filed: Apr. 7, 2015

Related U.S. Application Data
(60) Provisional application No. 61/976,327, filed on Apr. 7, 2014.

(51) Int. Cl. G06F 19/00

(52) U.S. Cl. CPC G06F 19/363; G06F 19/322

(57) ABSTRACT

A system for managing a clinical trial includes: a server programmed for establishing a database for clinical trial management by accessing form data, defining from the form data a plurality of forms and a plurality of associated form fields, defining a clinical trial structure and database fields from the form data; and a plurality of remote programmable devices, programmed to: direct the server to access the form data, including form correlation data and form use identifiers; send to the server information about patients participating in the clinical trial, the server assigning a patient identifier to each patient; and send to the server the patient identifier for one of the patients, receive from the server, in response to the patient identifier, a subset of the forms, receive input of trial data into form fields for the subset of the plurality of forms, and send the trial data to the server.

### CROSS REFERENCE TO RELATED APPLICATIONS

Priority is claimed U.S. provisional application No. 61/976,327, filed Apr. 7, 2014, the disclosure of which is incorporated herein by reference in its entirety.

### FIELD OF THE INVENTION

The field of the present invention relates to the field of management of clinical trial data, generation and further use, and more particularly to a system and method using medical informatics primarily to plan, conduct and analyze clinical trials and their results.

### BACKGROUND OF THE INVENTION

Over the past number of years, the pharmaceutical industry has enjoyed great economic success. The future for clinical trial data looks more challenging because of a large number of requirements put in place by the United States (US) Food and Drug Administration (FDA). The sheer number of requirements for clinical test data measurement alone renders the entire process time intensive and cumbersome.

In U.S. pharmaceutical companies alone, a huge percentage of total annual pharmaceutical research and development funds is spent on human clinical trials. Spending on clinical trials is growing at approximately 15% per year, almost 50% above the industry's sales growth rate. Trials are growing both in number and complexity. For example, the average new drug submission to the U.S. FDA now contains more than double the number of clinical trials, more than triple the number of patients, and a more than a 50% increase in the number of procedures per trial, since the early 1980s.

An analysis of the new drug development process shows a major change in the drivers of time and cost. The discovery process, which formerly dominated time to market, has undergone a revolution due to techniques such as combinatorial chemistry and high-throughput screening. The regulatory phase has been reduced due to FDA reforms and European Union harmonization. In their place, human clinical trials have become the main bottleneck. The time required for clinical trials now approaches 50% of the 15 years or so required for the average new drug to come to market.

The Trial Process Today

The conduct of clinical trials has changed remarkably little since trials were first performed in the 1940's. Clinical research remains largely a manual, labor-intensive, paper based process reliant on a cottage industry of physicians in office practices and academic medical centers.

Initiation:

A typical clinical trial begins with the construction of a clinical protocol, a document which describes how a trial is to be performed, what data elements are to be collected, and what medical conditions need to be reported immediately to the pharmaceutical sponsor and the FDA. The clinical protocol and its author are the ultimate authority on every aspect of the conduct of the clinical trial. This document is the basis for every action performed by multiple players in diverse locations during the entire conduct of the trial. Any deviations from the protocol specifications, no matter how well intentioned, threaten the viability of the data and its usefulness for an FDA submission.

The clinical protocol generally starts with a word-processor approach by a medical director who rarely has developed more than 1-2 drugs from first clinical trial to final regulatory approval and who cannot reference any historical trials database from within a company. In addition, this physician typically does not have reliable data about how the inclusion or exclusion criteria, the clinical parameters that determine whether a given individual may participate in a clinical trial, will affect the number of patients eligible for the clinical trial.

A pharmaceutical research staff member typically translates portions of the trial protocol into a Case Report Form (CRF) manually using word-processor technology and personal experience with a limited number of previous trials. The combined cutting and pasting in both protocol and CRF development often results in redundant items or even irrelevant items being carried over from trial to trial. Data managers typically design and build database structures manually to capture the expected results. When the protocol is amended due to changes in FDA regulations, low accrual rates, or changing practices, as often occurs several times over the multiple years of a big trial, all of these steps are typically repeated manually.

At the trial site, which is often a physician's office, each step of the process from screening patients to matching the protocol criteria, through administering the required diagnostics and therapeutics, to collecting the data both internally and from outside labs, is usually done manually by individuals with another primary job (doctors and nurses seeing ‘routine patients’) and using paper based systems. The result is that patients who are eligible for a trial often are not recruited or enrolled, errors in following the trial protocol occur, and patient data are often either not captured at all, or are incorrectly transcribed to the CRF from hand written medical records, and are illegible. An extremely large percentage of the cost of a trial is consumed with data audit tasks such as resolving missing data, reconciling inconsistent data, data entry and validation. All of these tasks must be completed before the database can be “locked,” statistical analysis can be performed, and submission reports can be created.

Implementation:

Once the trial is underway, data begins flowing back from multiple sites typically on paper forms. These forms routinely contain errors in copying data from source documents to CRFs.

Even without transcription errors, the current model of retrospective data collection is severely flawed. It requires busy investigators conducting multiple trials to correctly remember and apply the detailed rules of every protocol. By the time a clinical coordinator fills out the case report form the patient is usually gone, meaning that any data that was not collected or treatment protocol complexities that were not followed are generally unrecoverable. This occurs whether the case report form is paper-based or electronic. The only solution to this problem is point-of-care data capture, which historically has been impractical due to technology limitations.

Once the protocol is in place it often has to be amended. Reasons for changing the protocol include new FDA guidelines, amended dosing rules, and eligibility criteria that are found to be so restrictive that it is not possible to enroll enough patients in the trial. These “accrual delays” are among the most costly and time-consuming problems in clinical trials.

The protocol amendment process is extremely labor intensive. Further, since protocol amendments are implemented at different sites at different times, sponsors often don't know which protocol is running where. This leads to additional ‘noise’ in the resulting data and downstream audit problems. In the worst case, patients responding to an experimental drug may not be counted as responders due to protocol violations, but even count against the response rate under an intent-to-treat analysis. It is even conceivable that this purely statistical requirement could cause an otherwise useful drug to fail its trials.

Sponsors, or Contract Research Organizations (CROs) working on behalf of sponsors, send out armies of auditors to check the paper CRFs against the paper source documents. Many of the errors they find are simple transcription errors in manually copying data from one paper to the other. Other errors, such as missing data or protocol violations, are more serious and often unrecoverable.

Monitoring:

The monitoring and audit functions are one of the most dysfunctional parts of the trial process. They consume huge amounts of labor costs, disrupt operations at trial sites, contribute to high turnover, and often involve locking the door after the horse has bolted.

Reporting: As information flows back from sites, the mountain of paper grows. The typical New Drug Application (NDA) literally fills a semi-truck with paper. The major advance in the past few years has the addition of electronic filing, but this is basically a series of electronic page copies of the same paper documents—it does not necessarily provide quantitative data tables or other tools to automate analysis.

The Costs of Inefficiency:

It can be seen that this complex manual process is highly inefficient and slow. And since each trial is largely a custom enterprise, the same thing happens all over again with the next trial. Turnover in the trials industry is also high, so valuable experience from trial to trial and drug to drug is often lost.

The net result of this complex, manual process is that despite accumulated experience, it is costing more to conduct each successive trial.

In addition to being slow and expensive, the current clinical trial process often hurts the market value of the resulting drug in two important ways. First, the FDA reviews drugs on an “intent to treat” basis. That means that every patient enrolled in a trial is included in the denominator (positive responders/total treated) when calculating a drug's efficacy. However, only patients who respond to treatment and comply with the protocol are included in the numerator as positive responders. Not infrequently, a patient responds to a drug favorably, but is actually counted as a failure due to significant protocol non-compliance. In rare cases, an entire trial site is disqualified due to non-compliance. Non-compliance is often a result of preventable errors in patient management.

The second major way that the current clinical trail process hurts drug market value is that much of the fine grain detail about the drug and how it is used is not captured and passed from clinical development to marketing within a pharmaceutical company. As a result, virtually every pharmaceutical company has a second medical department that is a part of the marketing group. This group often repeats studies similar to those used for regulatory approval in order to capture the information necessary to market the drug effectively.

The Situation at Trial Sites

Despite the existence of a large number of clinical trials that are actively recruiting patients, only a tiny percentage of eligible patients are enrolled in any clinical trial. Physicians, too, seem reluctant to engage in clinical trials. One clinical trial by the American Society of Clinical Oncology found that barriers to increased enrollment included restrictive eligibility criteria, large amount of required paperwork, insufficient support staff, and lack of sufficient time for clinical research.

Clinical trials consist of a complex sequence of steps. On average, a clinical trial requires more than 10 sites, enrolls more than 10 patients per site and contains more than 50 pages for each patient's case report form (data entry sheet). Given this complexity, delays are a frequent occurrence. A delay in any one step, especially in early steps such as patient accrual, propagates and magnifies that delay downstream in the sequence.

A significant barrier to accurate accrual planning is the difficulty trial site investigators have in predicting their rate of enrollment until after a trial has begun. Even experienced investigators tend to overestimate the total number of enrolled patients they could obtain by the end of the clinical trial. Novice investigators tend to overestimate recruitment potential by a larger margin than do experienced investigators, and with the rapid increase in the number of investigators participating in clinical trials, the vast majority of current investigators have not had significant experience in clinical trials.

Absence of Information Infrastructure

Given the above state of affairs, one might expect that the clinical trials industry would be ripe for automation. But despite the desperate need for automation, remarkably little has been done.

While the pharmaceutical industry spends hundreds of millions of dollars annually on clinical information systems, most of this investment is in internal custom databases and systems within the pharmaceutical company; very little of this technology investment is at the physician office level. Each trial, even when conducted by the same company or when testing the same drug, is usually a custom collection of sites, procedures, and protocols. More than half of trials are conducted for the pharmaceutical industry by Contract Research Organizations (CROs) using the same manual systems and custom physician networks.

The clinical trials information technology environment contributes to this situation. Clinical trials are information-intensive processes—in fact, information is their only product. Despite this, there is no comprehensive information management solution available. Instead there are many vendors, each providing tools that address different pieces of the problem. Many of these are good products that have a role to play, but they do not provide a way of integrating or managing information across the trial process.

The presently available automation tools include those that fall into the following major categories:

Clinical data capture (CDC); Site-oriented trial management; Electronic Medical Records (EMRs) with Trial-Support Features; Trial Protocol design tools; Site-sponsor matching services; Clinical data management; Clinical Research Organizations (CROs) and Site Management Organizations (SMOs) also provide some information services to trial sites and sponsors.

Clinical Data Capture (CDC) Products:

These products are targeted at trial sites, aiming to improve speed and accuracy of data entry. Most are rapidly moving to Web-based architectures. Some offer off-line data entry, meaning that data can be captured while the computer is disconnected from the Internet. Most companies can point to half a dozen pilot sites and almost no paying customers.

These products do not create an overall, start-to-finish, clinical trials management framework. These products also see “trial design” merely as “CRF design,” ignoring a host of services and value that can be provided by a comprehensive clinical trials system. They also fail to make any significant advance over conventional methods of treating each trial as a “one-off” activity. For example, the companies offering CDC products continue to custom-design each CRF for each trial, doing not much more than substituting HTML code for printed or word-processor forms.

Site-Oriented Trial Management: These products are targeted at trial sites and trial sponsors, aiming to improve trial execution through scheduling, financial management, accrual, visit tracking. These products do not provide electronic clinical data entry, nor do they assist in protocol design, trial planning for sponsors, patient accrual or task management.

Electronic Medical Records (EMR) with Trial-Support Features:

These products aim to support patient management of all patients, not just clinical trial patients, replacing most or all of a paper charting system. Some EMR vendors are focusing on particular disease areas.

These products for the most part do not focus specifically on the features needed to support clinical trials. They also require major behavior changes affecting every provider in a clinical setting, as well as requiring substantial capital investments in hardware and software. Perhaps because of these large hurdles, EMR adoption has been very slow.

Trial Protocol Design Tools:

These products are targeted at trial sponsors, aiming to improve the protocol design and program design processes using modeling and simulation technologies.

None of the companies offering trial protocol design tools provide the host of services and value that can be provided by a comprehensive clinical trials system.

Trial Matching Services:

Some recent Web-based services aim to match sponsors and sites, based on a database of trials by sponsor and of sites' patient demographics. A related approach is to identify trials that a specific patient may be eligible for, based on matching patient characteristics against a database of eligibility criteria for active trials. This latter functionality is often embedded in a disease-specific healthcare portal such as cancerfacts.com.

Clinical Data Management:

There are products that support the back-end database functionality needed by sponsors to store the trial data coming in from CRFs. These products provide a visit-specific way of storing and querying clinical trial data. The protocol sponsor can design a template for the storage of such data in accordance with the protocol's visit schema, but these templates are custom-designed for each protocol. These products do not provide protocol authoring or patient management assistance.

Statistical Analysis:

The SAS Institute (SAS) has defined the standard format for statistical analysis and FDA reporting. This is merely a data format, and does not otherwise assist in the design or execution of clinical trial protocols.

Site Management Organizations (SMOs):

SMOs maintain a network of clinical trial sites and provide a common Institutional Review Board (IRB) and centralized contracting/invoicing. SMOs have not been making significant technology investments, and in any event, do not offer trial design services to sponsors.

Clinical Research Organizations (CROs):

CROs provide, among other services, trial protocol design and execution services. But they do so on substantially the same model as do sponsors: labor-intensive, paper-based, slow, and expensive. CROs have made only limited investments in information technology.

The Need for a Comprehensive Clinical Trials System:

It can be seen that the current information model for clinical trials is highly fragmented. This has led to high costs, “noisy” data, and long trial times. Without a comprehensive, service-oriented information solution it is very hard to get away from the current paradigm of paper, faxes and labor-intensive processes. And it has become clear that simply “throwing more bodies” at trials will not produce the required results, particularly as trial throughput demands increase. A new, comprehensive model is required, particularly one that leverages existing more than performing an electronic implementation of the old ways.

### SUMMARY OF THE INVENTION

The present invention is directed toward a system and method for clinical trial management, both of which provide visual design methodology for designing and modifying a clinical trial. The design and modification methodology may take a dynamic system approach to capture clinical trial design requirements, which optimizes and validates the clinical trial design during the entire clinical trial process, using clinical trial metadata and a computing device. Clinical trial metadata may include clinical trial name, forms, roadmap, visits, and validations. The system and method may also produce documents ready for submission to the FDA using intuitive design and embedded analytics. In addition, the system and method may provide functionality to track and trace real-time alterations during the entire clinical trial process, thereby eliminating accrual delays by shrinking extensive channelization and collaboration of geographically distributed controlling components.

In a first separate aspect of the present invention, a system for managing a clinical trial, the system includes: a server including a programmable processor, a memory, and a non-volatile storage device, the server programmed for establishing and maintaining a database for clinical trial management and for sending data from and receiving data into the database, and a plurality of remote programmable devices, each remote programmable device being configured to communicate with the server over a network. Establishing the database, by the server, includes accessing form data, defining from the form data a plurality of forms and a plurality of form fields associated with the plurality of forms, defining a clinical trial structure from the form data, and defining database fields from the form data. At least a first of the plurality of remote programmable devices is programmed to direct the server to access the form data, the form data including form correlation data, from which the server defines associations between the plurality of form fields and the plurality of forms within the database, and a plurality of form use identifiers, from which the server defines the clinical trial structure. At least a second of the plurality of remote programmable devices is programmed to send to the server information about patients participating in the clinical trial, the server assigning a patient identifier to each patient. At least a third of the plurality of remote programmable devices is programmed to communicate to the server the patient identifier for a first of the patients, receive from the server, in response to the patient identifier, a first subset of the plurality of forms, receiving an input of trial data into one or more of the form fields associated with the first subset of the plurality of forms, and communicating the trial data to the server for incorporation into the database.

In a second separate aspect of the present invention, a system for managing a clinical trial includes: a server including a programmable processor, a memory, and a non-volatile storage device, the server configured to communicate over a network with a plurality of remote programmable devices. The server is programmed for: establishing a database for clinical trial management by receiving form data from at least a first of the plurality of remote programmable devices, defining from the form data a plurality of forms and a plurality of form fields associated with the plurality of forms, with associations between the plurality of forms and the plurality of form fields being determined by correlation data included in the form data, defining a clinical trial structure from a plurality of form use identifiers included in the form data, defining database fields from the form data, and from the database fields, defining the database; receiving from at least a second of the plurality of remote programmable devices information about patients participating in the clinical trial and assigning a patient identifier to each patient; and receiving from at least a third of the plurality of remote programmable devices the patient identifier for a first of the patients, sending to the third of the plurality of remote programmable devices, in response to receiving the patient identifier, a first subset of the plurality of forms, and receiving for incorporation into the database trial data input into one or more of the form fields associated with the first subset of the plurality of forms on the third of the plurality of remote programmable devices.

In a third separate aspect of the present invention, a method for managing a clinical trial using a server including a programmable processor, a memory, and a non-volatile storage device, the server configured to communicate over a network with a plurality of remote programmable devices, the method including: establishing, with the server, a database for clinical trial management by receiving form data from at least a first of the plurality of remote programmable devices, defining from the form data a plurality of forms and a plurality of form fields associated with the plurality of forms, with associations between the plurality of forms and the plurality of form fields being determined by correlation data included in the form data, defining a clinical trial structure from a plurality of form use identifiers included in the form data, defining database fields from the form data, and from the database fields, defining the database; receiving from at least a second of the plurality of remote programmable devices information about patients participating in the clinical trial and assigning a patient identifier to each patient; and receiving from at least a third of the plurality of remote programmable devices the patient identifier for a first of the patients, sending to the third of the plurality of remote programmable devices, in response to receiving the patient identifier, a first subset of the plurality of forms, and receiving for incorporation into the database trial data input into one or more of the form fields associated with the first subset of the plurality of forms on the third of the plurality of remote programmable devices.

Accordingly, an improved system and method for clinical trial management are disclosed. Advantages of the improvements will be apparent from the drawings and the description of the preferred embodiment.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 schematically illustrates a system for managing a clinical trial;

FIG. 2 schematically illustrates logical and physical components of a system for managing a clinical trial;

FIG. 3 is a flowchart showing an overview of a clinical trial process;

FIG. 4 is a flowchart showing an embodiment of a process for the initial set-up of a database for a clinical trial;

FIG. 5 illustrates a sample form which may be incorporated into a database of a clinical trial;

FIG. 6 is a flowchart showing a process of importing a form from a file;

FIG. 7 is a screen shot showing a chart with task categories associated with building a clinical trial;

FIG. 8 is a role privileges chart associated with the building process for a clinical trial;

FIG. 9 shows a dashboard screen associated with the building process for a clinical trial;

FIG. 10 shows a sample search results screen associated with the building process for a clinical trial;

FIG. 11 shows a navigation console screen associated with the building process for a clinical trial;

FIG. 12 shows a study status screen associated with the building process for a clinical trial;

FIG. 13 shows a study design screen associated with the building process for a clinical trial;

FIG. 14 shows a roles and privileges screen associated with the building process for a clinical trial;

FIG. 15 shows a study team screen associated with the building process for a clinical trial;

FIG. 16 shows a workflow screen associated with the building process for a clinical trial;

FIG. 17 shows a forms list screen associated with the building process for a clinical trial;

FIG. 18 shows a form repository screen associated with the building process for a clinical trial;

FIG. 19 shows a form edit screen associated with the building process for a clinical trial;

FIG. 20 shows a form field attribute screen associated with the building process for a clinical trial;

FIG. 21 shows a list entry screen associated with the building process for a clinical trial;

FIG. 22 shows a visits roadmap screen associated with the building process for a clinical trial;

FIG. 23 shows a mapping screen associated with the building process for a clinical trial;

FIG. 24 shows an edit check screen associated with the building process for a clinical trial;

FIG. 25 shows a test script screen associated with the building process for a clinical trial;

FIG. 26 shows a first test automation screen associated with the building process for a clinical trial;

FIG. 27 shows a second test automation screen associated with the building process for a clinical trial;

FIG. 28 shows a test automation status screen associated with the building process for a clinical trial;

FIG. 29 shows a study preview/download screen with standard outputs associated with the building process for a clinical trial;

FIG. 30 shows a study preview/download screen with customized outputs associated with the building process for a clinical trial;

FIG. 31 shows a task allocation screen associated with the building process for a clinical trial;

FIG. 32 shows a unit testing screen associated with the building process for a clinical trial;

FIG. 33 shows a script screen associated with the building process for a clinical trial;

FIG. 34 shows a functional testing screen associated with the building process for a clinical trial;

FIG. 35 shows a first UAT test case list screen associated with the building process for a clinical trial;

FIG. 36 shows a UAT test case edit screen associated with the building process for a clinical trial;

FIG. 37 shows a second UAT test case list screen associated with the building process for a clinical trial;

FIG. 38 shows a UAT test case execution screen associated with the building process for a clinical trial;

FIG. 39 shows a audit trail screen associated with the building process for a clinical trial;

FIG. 40 shows a version list screen associated with the building process for a clinical trial;

FIG. 41 shows a version compare screen associated with the building process for a clinical trial; and

FIG. 42 shows a comments screen associated with the building process for a clinical trial.

### DETAILED DESCRIPTION OF THE INVENTION

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g. code). Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short, and multiple programmable devices in mutual communication is referred to as a “programmable system”. It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disc, and others), which may be written to and/or read by a processor operably connected to the medium.

As used herein, the terms “clinical trial” and “clinical study” are used interchangeably.

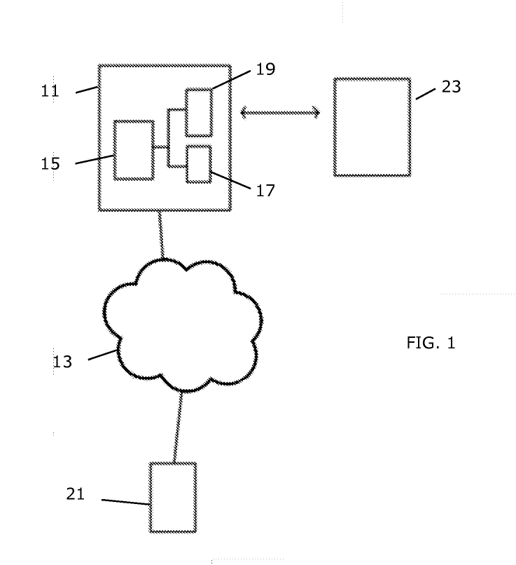

A system for clinical trial management is illustrated in FIG. 1. The system includes a server 11 which operates in a networked environment to interact with other programmable devices and networks. The network environment may include and operate over a public network such as the Internet 13, over a private network, or any combination of public and private networks. The networks themselves may be wired networks, wireless networks, or any combination of wired and wireless networks. The server in the embodiment shown includes a processor 15, a volatile memory 17, and a non-volatile storage device 19. The non-volatile storage device 19 may include one or more non-volatile memory spaces. Additional processors, volatile memory spaces, and non-volatile storage devices may be included as desired based on specifications of a particular implementation.

In the embodiment illustrated, the server 11 is networked using the Internet 13, which serves as a public network, to the remote devices 21, each of which is a programmable device. Although the server will generally be networked to multiple remote devices simultaneously, in order to allow access from multiple points and management of multiple clinical trials by multiple users, only the three are shown for purposes of simplifying the ensuing description. Moreover, each remote device 21 may be programmed to perform any part or all of the server interaction functions described below in connection with the clinical trial management system. Each remote device 21 serves as a point of data input and data acquisition for the one or more databases 23 maintained by the server 11. Each remote device 21 may be any type of programmable device, independently of the other remote devices 21, such as any desktop or mobile device, such as a workstation, a desktop computer, a laptop computer, a notebook, a tablet, a cellular phone, and the like. The server 11 may use any desired protocols and file formats to electronically communicate with the remote devices 21 that are deemed appropriate for the specifications of a particular implementation.

The server 11 interacts with the remote devices 21 to gather and compile information into the clinical trial management database 23 maintained by the server 11, one embodiment of which is described in greater detail below. To this end, the server 11 is programmed to perform the data gathering, data compilation, and database functionality that is described in further detail below, though interaction with multiple users during the course of a clinical trial. The server 11 may also be programmed to distribute data from the database to other servers or programmable devices using one or more application program interface (API), although such functionality is beyond the scope of the present disclosure. Those of skill in the art will recognize that the clinical trial management database 23 for any one clinical trial may be maintained as a single, integrated database, or it may be maintained as multiple relational databases. In addition, the databases for multiple clinical trials may be maintained in a combined database, or the server 11 may maintain each clinical trial as a separate database. For purposes of the description below only, the clinical trial management database is treated as being a single, integrated database for a single clinical trial.

In gathering and compiling data as part of managing a clinical trial, the server 11 is programmed to communicate with the remote devices 21 as appropriate to gather designated data for creating the database 23 for the clinical trial and for insertion into the database 23 once it is created. Typically, the remote devices 21 will initiate communication with the server 11 to provide data for the database 23. The server 11 may, at times, also initiate communications with any of the remote devices 21 in order to gather or verify data for the database.

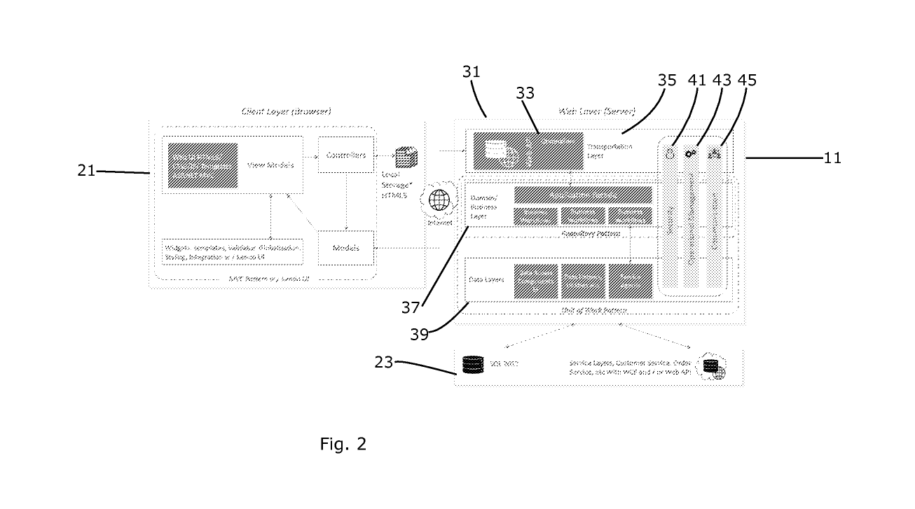

FIG. 2 illustrates logical components of one embodiment of the clinical trial management process overlaid with physical components, including the server 11, a remote device 21, and the database 23. The remote device 21 may interact with the server 11 through a web browser interface using hypertext markup language (HTML), preferably HTML version 5, which may be used in combination with other programming languages, such as Java™ and Microsoft's .net platform, among others. Through the use of HTML5, and maybe other programming languages, the server 11 is able to provide the remote device 21 with the programming necessary to carry out the processes described herein to exchange data of all types with the server. For certain aspects of functionality, the remote device 21 may rely on programming that is not received from the server 11, such as the web browser, an operating system, programming received from a source other than the server 11, and the like. For example, as shown in FIG. 2, the remote device 21 may include programming so that it operates using a model-view-controller architectural format to generate the user interface and impart the user interface with the desired functionality, thereby enabling the presentation of data to and the collection of data from the user. In such an architectural format, the data exchanged with the server 11 that is read from and written to the data base is part of the model, the programming received from the server, in conjunction with the web browser engine, serves as the controller, and the web browser itself is the viewer. The web browser may use or access additional widgets, templates, styles, and the like to provide the viewer functionality.

The server 11 may use a web layer 31 which interfaces with the database 23, and the web layer 31 may also interface with other programming layers 33 to provide additional functionality, such as service layers, a customer service layer, an order service layer, or other application programming layers. In certain embodiments, the database 23 is implemented as a SQL database. The web layer 31 itself may include multiple programming layers, such as a transportation/presentation layer 35, a business layer 37, and a data layer 39. The web layer 31 may also include a security module 41, an operational management module 43, and a communication module 45, and each of these modules 41, 43, 45 may span any or all of the programming layers.

The transportation/presentation layer 35 includes controllers which are programmed to render, produce, and/or generate HTML pages, cascading style sheets (css), Javascript, HTML templates, images, PDF documents, form documents, and documents ready for submission, and the like. The transportation/presentation layer 35 is also programmed to produce renderings needed for the user interface and to manipulate data. While HTML pages are created to be rendered within a browser, the transportation/presentation layer 35 may also be programmed to generate documents and/or forms at the server 11 for transmission to one or more of the remote devices 21. Once an HTML page is generated by the server 21, the page is transmitted to the remote device 21, where client-side components (browser/user agent) execute scripts and displays the HTML using web browser software on the remote device 21. The transportation/presentation layer 35 may use client-side techniques such as asynchronous JavaScript and XML (AJAX) and rich client-side frameworks to execute logic on the client, for building fluidic user experiences.

A separate service layer may exist with the transportation/presentation layer 35, with the separate service layer provided to expose business entities/logic using application programming interfaces (APIs) over the Internet. Internet-based APIs (also referred to as web-APIs) serve as a good platform for building pure hypertext protocol (HTTP) based services where the request and response happens via the HTTP protocol. The system and method may use HTTP services to enable reaching a broad range of remote devices (also referred to as client devices) which run web browsers, whether the remote devices are desktop computers or mobile devices such as phones and tablets. The server 11 may also use a token-based request and response system to authenticate user to access data from the web API.

The separate business layer 37 is responsible to implement business logic and workflows, allowing the system 11 to centralize and reuse common business logic functions.

The data layer 39 is responsible for facilitating access to the database 23, which may reside on an SQL server, such that authenticated calls are used to access the database 23. The data layer 39 may include an entity framework which enables the server 11 to use custom data classes together with the data model without making any modifications to the data classes themselves. Through the use of the entity framework, the server 11 can use “plain-old” common language runtime (CLR) objects that are used in the Microsoft® .net framework, such as existing domain objects, alongside the data model. These data classes (also known as persistence-ignorant objects), which may be mapped to entities that are defined in the data model, support most of the same query, insert, update, and delete behaviors as entity types that are generated by the entity data model tools, thus making the two easy to use in conjunction with each other.

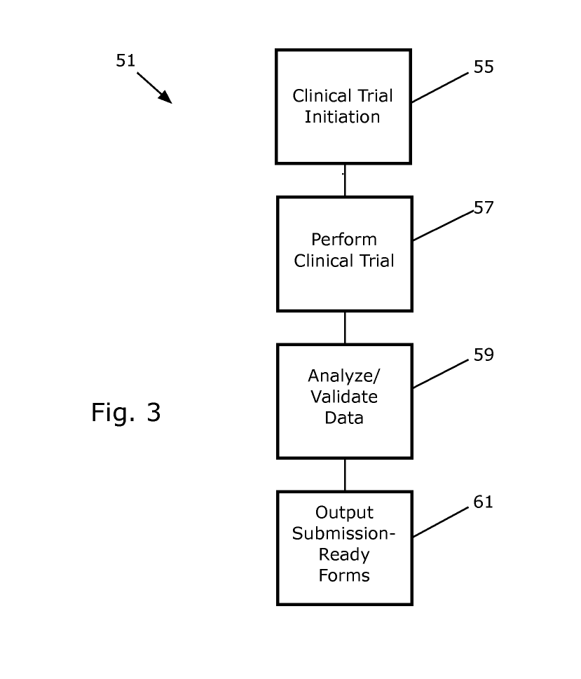

A flowchart 51 showing an overview of a clinical trial process, from study initiation to output of submission-ready documents, is shown in FIG. 3. All steps are performed between the server and one or more user devices. The same user device need not necessarily be used for each step of the process, and the same user device need not necessarily be used for completion of any single step. Since the process of building a clinical trial is generally a collaborative process, throughout each step, the server is accessed by a plurality of remote devices, each accessing the server, and thus the database, for a different purpose in order to perform one or more tasks associated with each step of building a clinical trial. During each step of the process, the data sent from the server to a remote device, and the data input at a remote device and sent to the server, may have different characteristics. For example, at certain steps of the process, the data may be purely information being provided or collected (such as information provided to a physician from the database, or patient information collected by a physician and being submitted to the database). At other steps of the process, the data may be programming intended to be executed, either by the server or by the remote device. At still other steps of the process, the data may be a mix of information and programming. The term “data” is therefore to be interpreted broadly, referring to any communications exchanged between a remote device and the server.

The first step is the clinical trial initiation 55, also referred to as the clinical trial build. The clinical trial build may include several stub-steps, with a user interacting, through the remote device, with the server to view data and input data. One of the first sub-steps is to set up the clinical trial for being built, which may include assigning a title to the clinical trial and identifying and assigning user roles, users, and user/user role privileges. With initial user and user roles defined, one of the identified users may begin the build process, which includes uploading form data to the server for incorporating into the clinical trial, with the upload effectively instructing the server to access the uploaded data. The beginning of the build process may also include uploading trial schedule data for incorporation into the clinical trial by the server. In certain embodiments, the form data and the clinical trial data may be uploaded to the server as unified a data set. For example, the form data and schedule data may be incorporated into an architect loader spreadsheet (ALS) which is uploaded to the server, with the upload effectively instructing the server to access the uploaded data. In other embodiments, the form data and the trial schedule data may be already accessible to the server as part of another clinical trial, thus making uploading unnecessary. In such instances, a user would access the server to identify the form data and trial schedule data in the other clinical trial, so that the server, may then access and import the identified form data and trial schedule data into the clinical trial presently being built. In other embodiments, the form data and trial schedule data may be created directly by interaction between the user, through the remote device, and the server. In such instances, the user may access the server to define forms and form fields, and to define the trial schedule, thereby building the form data and the trial schedule data from the ground up. In still other embodiments, any combination of two or more of these methods of incorporating form data and trial schedule data into the clinical trial may be used.

From the form data and the trial schedule data, the server begins to build the database for the clinical trial. The form data is used to define forms and form fields for each define form within the database, and each form and form field may be assigned a unique identifier to facilitate organization and management of the clinical trial. The form data also includes form use identifiers, which are may be already incorporated into pre-existing form data, or it may be added to the form data by the user before or at the time the form data is provided to the server. A form use identifier defines when, within the context of the clinical study being built, the form is to be used. Using the form use identifiers, the server maps each form incorporated into the database to one or more points within the trial schedule. The mapping of forms to the trial schedule creates predetermined usages for each form during the clinical trial. For example, certain forms may be mapped to particular patient visits, and certain forms may be mapped to the end of the clinical trial to generate submission-ready output. Forms may be mapped to any point within the trial schedule as is appropriate for a particular clinical trial. The combination forms mapped to the clinical trial schedule within the database serves to define the basis of the clinical trial structure. This clinical trial structure determines the scheduled visits for patients participating in the clinical trial, the type of data to be collected from each patient during each visit, and the time frame for completion of the clinical trial.

With the basic clinical trial structure in place, the user, through one of the remote devices, may interact with the server to further build the clinical trial structure into the fully operational clinical trial. Building the clinical trial may include adding additional database fields to the database for use during the build process and while the clinical trial is being conducted. One example of a database field that should be added is a patient identification field, so that patients participating in the clinical study may be assigned a unique patient identification number that is used to identify them during the course of the clinical study. Database fields which include programming may also be added to the database, with such database fields being used by the server and/or the remote devices to perform automated tasks and add functionality to both the build process and while the clinical trial is being conducted.

Once the clinical trial is built, and it is believed to be complete, or at least at a stage that is ready for testing, then functional testing of the current build of the clinical trial may begin. Functional testing may be an iterative process, through which the clinical trial build is tested, revised, and retested, with the cycle continuing until the clinical trial being built meets the standards that are established at the outset by one or more of the users. Functional testing may include testing the interaction between different database fields when patient data is added, testing whether database fields are properly configured to accept the type of data they are intended to receive, testing programming associated with the database and clinical trial, and the like. Thus, testing may include several steps, such as: unit testing, script testing, scenario testing execution testing, and user acceptance testing (UAT). After all testing is passed, to the satisfaction of the study organizer and/or one of the users, and only after all testing is passed, is the clinical trial ‘pushed to live’ by the server—in other words, the clinical trial is then made available for actual use as a clinical trial.

With the clinical trial hosted by the server going live, then the actual clinical trial itself may be performed 57. As with any clinical trial, one of the first steps is to arrange for physicians to participate in the clinical trial and to identify appropriate patients as study participants. Patients who participate in the study may be assigned a unique patient identification number by which each is referenced within the context of the database and the clinical trial. During the course of the clinical trial, as the patient visits a medical professional, the medical professional may use one of the remote devices to access the server, and thus the database. By identifying the patient to the server through, for example, the unique patient identification number, the server will provide to the remote device all forms associated with the patient's next scheduled visit within the context of the clinical trial. In this manner, the forms can inform the medical professional the purpose of the visit, the questions that need to be asked of the patient, and collect medical and personal data (the trial data) from the patient based on the forms provided by the server for that visit. The medical professional enters the medical and personal data for the patient into each form presented on the remote device for that visit, and the remote device then communicates the entered data to the server for entry into the database. Moreover, because of the programming included in the clinical trial build, the remote device is programmed, through the forms, to present conditional questions to the medical professional only when the answer from a patient to a threshold question meets the proscribed condition. In this manner, collection of the desired medical and personal data for the database is facilitated by the presentation of the forms. Through this process, the relevant medical and personal data about each patient is collected and stored within the database for each visit. In addition, in the event that any forms change during the course of the clinical study, the server is able to provide the most current version of all forms for each patient visit.

Certain clinical trials may be designed so that a first set of forms presented for a first category of patients are different than a second set of forms presented for a second category of patients within the same clinical trial. For example, a clinical trial may be designed to present the first set of forms to the medical professional for all male patients participating in a clinical study, while the second set of forms are presented to the medical professional for all female patients participating in the clinical study. The first and second sets of forms may include some of the same forms, such as an initial intake form, or other forms reporting general health, while also including many forms that are not the same for each category of patient.

The database may include programming that enables the server and/or the remote devices to analyze and/or validate 59 the data collected from and about each patient as part of the clinical trial. Alternatively, such programming may be stored separately from the database and accessed by the server. As a final step in the clinical trial, the server may output 61 submission-ready forms from the database to one of the remote devices, i.e. the forms output are in a format requested for submission by the target government agency. The server may be programmed to provide output in a plurality of formats, such as in a Study Data Tabulation Model (SD™) format, an Analysis Data Model (ADaM) format, and the like.

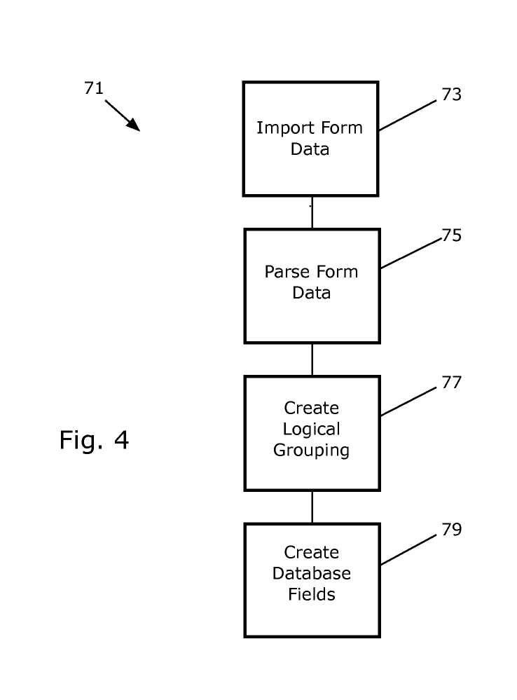

An embodiment of a process for the initial set-up of the database is shown in the flowchart 71 of FIG. 4. The building process of the database begins with the server importing form data 73. The form data may be imported from nearly any source. For example, form data may be imported from: one of the remote devices, a previous clinical trial, a clinical trial template, or from another source to which the server is directed by a user through one of the remote devices. As indicated, a form is a logical grouping for form fields, and each form gets mapped to the clinical trial schedule. Forms may be imported one at a time, several at a time, by files of spreadsheets, of extensible markup language (XML), and the like. A form may also be imported as or after a user creates the form using one of the remote devices. When forms are imported using a file, the file may also include additional information for incorporation into the database, such as the trial schedule, and any other data that is used to create a database field within the database.

In the case of importing a single form, after a form is imported by the server, the server then parses 75 the form data/elements to identify form fields. Once the form fields are parsed, the server creates a logical grouping 77 to maintain a correlation between the identified form fields so that they all remain associated with the imported form. The form fields are then used to create database fields 79, insofar as there is not already an existing database field for a recurring form field, and the logical grouping is entered into a database field intended for storing the logical grouping information. Of course, creation of the database fields may occur concurrently with identifying the form fields and creating the logical grouping. The final step in the initial set-up of the database is the creation of a database field for the trial schedule and to create a relationship between the imported forms and form fields with the trial schedule. For a single form, the user may input the trial schedule directly and manually associate imported forms with the trial schedule.

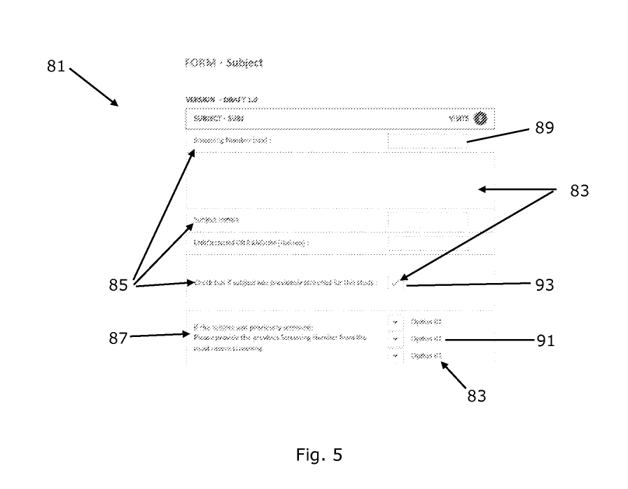

A sample form 81 is shown in FIG. 5. This form shows a plurality of fields 83 which are to be filled in by an attending medical professional about the patient during one of the visits. Each form field 83 is accompanied by a short description 85 of the associated form field 83 or instructions 87 for filling out the associated form field 83. Different types of form fields 83 may be included with any form. This sample form 81 includes a fill-in-the-blank type form field 89, a drop-down form field 91, and a check box form field 93. Other types and/or styles of form fields may be included in a form incorporated into the database.

The database that is created includes a database field representing each form field that is imported or created by a user, with only one database field included for the representation of recurring form fields, and at least one database field representing the trial schedule. The database will also include database fields to identify the logical groupings of form fields that make up a form. The database may also include many other database fields which server other purposes, such as to impart functionality to the system, to store other forms of data, to store metadata, and the like. Depending on the type of form field, the database fields representing the form fields may be populated during the build process for the clinical trial or during the course of the clinical trial itself. Database fields that provide information only may generally be populated during the build process, while database fields used to collect data during the clinical trial are populated during the clinical trial. The database field for the trial schedule is populated during the build process to set the trial schedule and identify the forms to be used at each patient visit. Similarly, database fields that have other uses, such as imparting functionality to the server (such as for testing purposes) and/or to the remote devices (such as for programming to be executed within a browser), may be populated during the build process.

As indicated, a single form that is incorporated into the clinical trial is considered a logical grouping of form fields, and the collection of forms and form fields defines only part of the database fields that make up the database. In addition to form fields, form data also includes, either explicitly or implicitly, form correlation data, which includes two components. The first component of form correlation data defines the form fields that are assembled to construct a single form which is to be used as part of the clinical study. In other words, the first component defines the logical relationship between a group of form fields that constitute any one of the forms. Thus, the form data for a single form identifies each form field associated with the form and identifies the group of form fields as the logical grouping that makes up the single form. The second component of form correlation data is an indicator, which may be express or implied, that the same form field is used in two or more forms. For example, a patient identifier may be used across nearly all form fields associated with a clinical trial. Similarly, a form identifier field, which may contain a unique identification for each form, may also be used across all forms. In contrast, a medications history field or a phone number field for the patient may only be used on a few select forms, as needed. Thus, where a form field is used across multiple forms, the form correlation data provides an indication to the server that only one database field should be created for the recurring form field, and that the database should reflect use of that form field across a plurality of forms.

For the mapping step, the database includes a database field representing the trial schedule, and each form identified within the database is associated with the trial schedule in some way by mapping the form to one or more time points within the trial schedule. Forms that are needed for patient visits are mapped to patient visits. Other forms may be needed only for the output of submission-ready documents, and as such, those forms need not be mapped to any patient visits, but rather only need to be available at the conclusion of the clinical study.

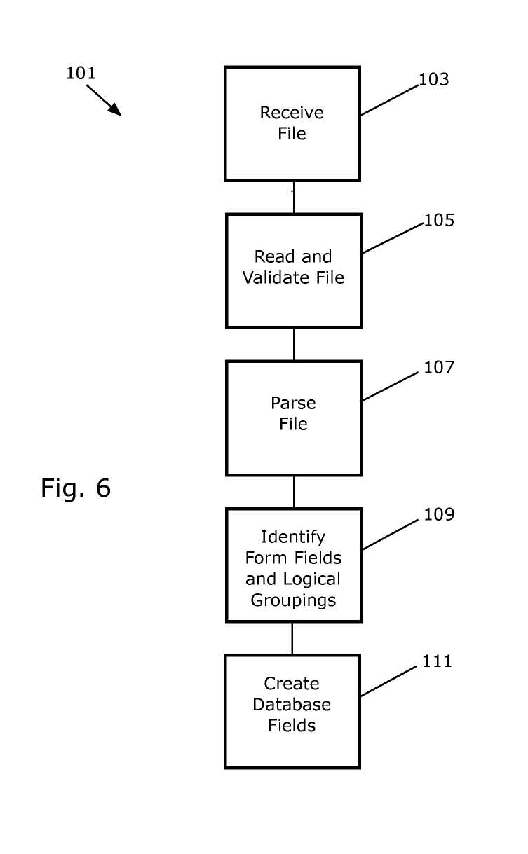

A flowchart 101 showing the process of importing a form from a file is shown in FIG. 6. When importing files which define multiple forms, after the server receives the file 103, the server is programmed to read and validate 105 the uploaded file. Validation is performed to insure that the file being uploaded is in the format the user believes it is in, and to insure that the file is properly formed with respect to the file format. For example, a user may submit what is believed to be an Architect Loader Spreadsheet (ALS) file format, an XML file format, an Operational Data Model (ODM) file format, a portable document format (PDF) file format, or other similar file formats, and the server will verify that the imported file is, indeed, in the asserted format. A poorly formed file would result in errors at best, or the creation of database fields that are irrelevant to the clinical trial being built. Once the imported file is validated, then the import process begins. During the import process, the server is programmed to parse 107 the imported file, identify 109 the form fields and logical groupings from the file, and create 111 the database fields from the information in the imported files. When the imported file also includes trial schedule data, the server may also be programmed to create associations between the imported forms and the trial schedule. The user may edit any of the form data and trial schedule data that are imported from a file.

Once the clinical trial is set up and pushed live, the clinical trial may be modified, should such be necessary, through modification of the database. Modification of the database involves modifying any one or more forms, modifying the trial schedule, modifying the point or points within the trial schedule with which one or more forms is associated, or modifying any other element or sub-element within the database. Once a modification is made, the server can automatically incorporate the modifications into the live clinical trial. Thereafter, any modifications to the database that affect forms will be presented to users accessing the database from a remote device. Thus, the clinical trial may be dynamically changed while the clinical trial is in process. In the event that any protocol issues are identified with the clinical trial, those issues may be addressed dynamically during the clinical trial, so that the data collected during the clinical trial may still remain relevant for the purpose of the clinical trial and eventual submission to an appropriate government agency.

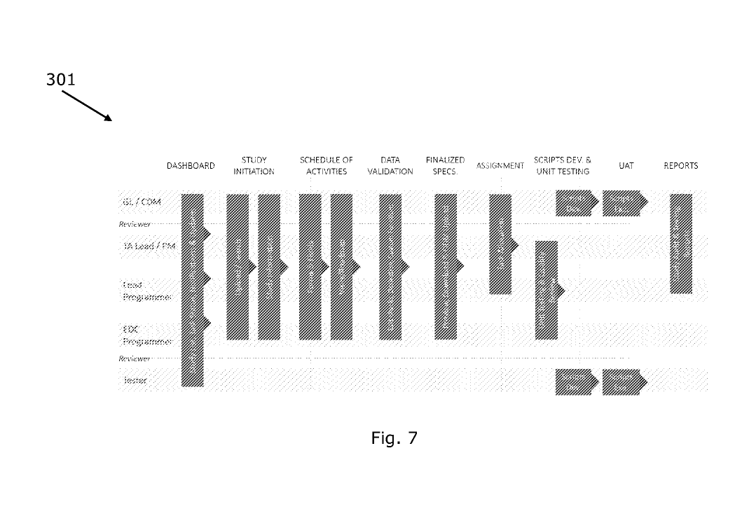

FIGS. 7-44 show screen shots of a particular implementation of the server 11 interacting with a remote device to build and manage a clinical trial. In the discussion below for this particular implementation, all screen displays are an example of a screen which may be shown on one of the remote devices for purposes of interacting with the server. In this particular implementation, the server controls the screen that is displayed on the remote device by sending to the remote device information in a protocol (such as HTTP) that may be rendered within a browser on the remote device. The information may also include or call on programming for execution, such as Java™ or Javascript™, or another programming or scripting language. In addition, where information is input by a user using a remote device, the remote device is programmed to communicate the input information to the server, and the server is programmed to store that information in the database for the clinical trial, or alternatively, store the input information in a file structure that is associated with the database for the clinical trial, such that the information is readily accessible during the build process for the clinical trial and during the time the clinical trial is conducted.

FIG. 7 is a screen shot showing a chart 301 with various task categories associated with building a clinical trial. The chart also shows the various user roles which are associated with each of the task categories. The task categories for building a clinical trial, in this embodiment, are listed across the top, including: study initiation; creating a schedule of activities; data validation; finalize specifications for the clinical study; task assignment; scripts development and unit testing; user acceptance testing; and reports. In this chart 301, the different user roles are listed down the left side, including: a global librarian (GL); a clinical data manager (CDM); a therapeutic area (TA) lead; a project manager (PM); a lead programmer (LP); an electronic data capture (EDC) programmer; and a tester. The gray bars in the middle of the chart 301 show the tasks in which each user role participates during the course of building a clinical trial. For some clinical trials, an individual user may fill multiple roles. For example, the GL may also serve as the CDM; and the TA lead may also serve as the PM. Other roles may also be defined for purposes of building and managing a clinical trial, although not all roles have enough significance within the establishment and management of a clinical trial so as to bear listing in FIG. 7. For example, there may be other database programmers, in addition to the LP, who work on the project and are not listed, there may be statistical programmers, who are responsible for at least the data analysis capabilities that are programmed, and there may be software programmers responsible for the user interface presented on the remote devices. Depending upon the implementation, one or more of such other roles may be significant enough to be included on the chart 301. In addition, any number of other roles that are not included on the chart 301 may be defined as part of the system and process of building a clinical trial.

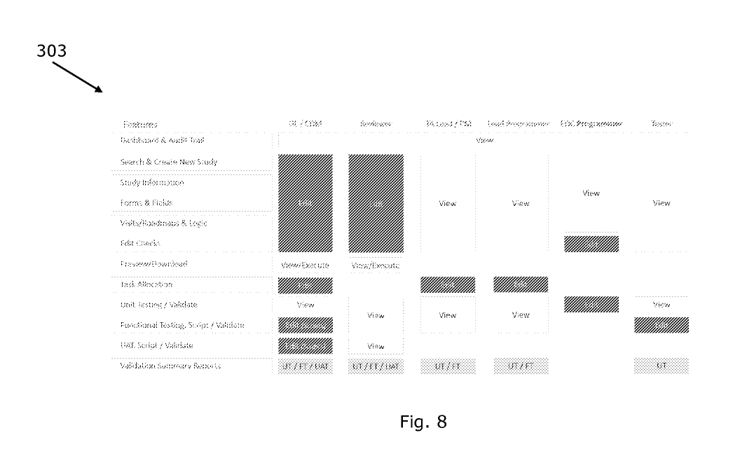

FIG. 8 is a role privileges chart 303 showing user role privileges that may be set by the GL or a CDM as part of the clinical trial initiation task category. In the role privileges chart 303, the different user roles are listed across the top, and the various task categories for preparing a clinical trial to go live are listed down the side. The middle of the chart 303 indicates which user roles have edit and view privileges for the various task categories, and for the reports, the chart 303 indicates the types of reports users in each role receives.

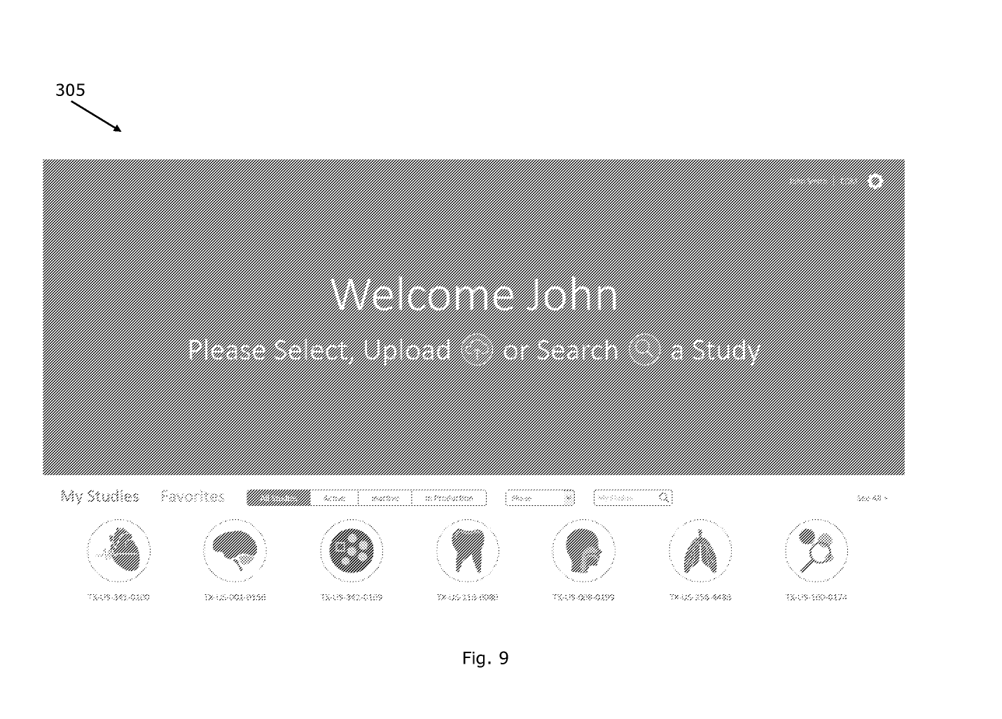

A dashboard screen 305 that may be shown on a remote device for creating and managing a clinical trial is shown in FIG. 9. The dashboard screen 305 may include multiple views/consoles that display different information, depending on the most recent choice or item selected. Upon logging into the server 11, a user is presented with the dashboard screen 305 as a welcome console. The dashboard screen 305 may present only those functions to which a user has access, based on the privileges of the user's role. The dashboard screen 305 includes an upload link to allow the user to upload data, such as form data, and a search link to perform a search within a study or across studies. A list of most recent studies the user has accessed may be presented, or alternatively a link to the user's most recent studies. Widgets are also displayed on the dashboard 305, with each widget giving the user access to a different function for creation and/or management of a clinical trial.

The dashboard screen widgets may include:

Upload Widget—

The upload widget allows the creation of a new clinical study from an appropriate ALS file.

Search Widget—

The search widget may include an autocomplete search feature so that a search may be performed to find an existing study or template stored on the server or within accessible clinical trial databases. The search widget may also be used to search by using components of a clinical study, a clinical study template ID, or by the therapeutic area of other accessible clinical studies. The clinical study or template found from a search may then be used to create a new clinical study or a new template.

Settings Widget—

The settings widget may allow a user to change user roles (when a user has multiple user roles assigned), manage the user's account, such as for changing passwords, logout of the system, and/or contact a support team for assistance with using the system.

My Studies Widget—

The my studies widget provides a view to the most recently accessed studies and a link to all studies to which the user has assigned responsibilities. Users can filter and view studies by selecting the appropriate categories from the “All Studies,” “Active,” “Inactive,” and “In Production” filter tabs, and by selecting the desired phase of a clinical study from the “Phase” drop-down list. Active, Inactive and In Production studies associated with the selected Phase are returned in the search results.

Favorites Widget—

The favorites widget allows the user to mark those clinical studies and/or clinical study templates which may be frequently used for quick access. This allows the user to quickly select a clinical study or clinical study template as a base for creating new clinical study or clinical study template.

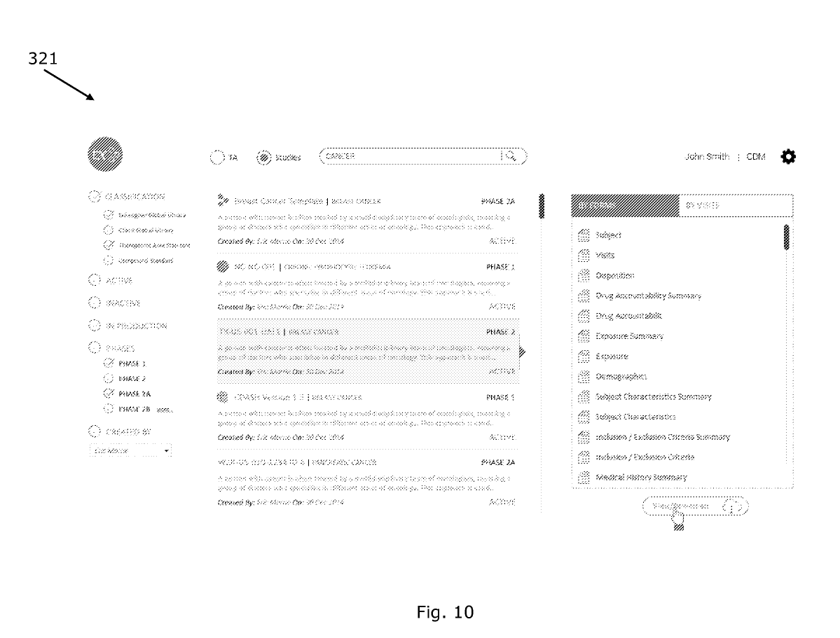

A sample search results screen 321 is shown in FIG. 10. The search functionality may narrow the search based on the information entered into the search criteria. For example if just an “onc” is entered in the search criteria field, all clinical studies and/or clinical study templates containing “onc” will appear in the list. In addition, by selecting search results may by further filtered by selection of searching a specific TA or just searching studies by the radio buttons near the search field.

Advanced search features may help a user to reach a desired search result by making combination of filters available. Such advanced search features may include limiting the results based upon:
Classification—Type of Study/Template as
   GL—Global Library
   CGLS—Client Global Library Standard
   TAS—Therapeutic Area Standard
   CPS—Compound Standard
Active—All Active studies only
Inactive—All Inactive studies only
In Production—All In Production studies only
Phases/Class—Specific selection of Phase “Pharma/Drug”/Class “Device” studies only
Created by—CDM specific studies only

When a particular clinical study is selected from the search results, the user may select to display the list of forms associated with that clinical study, or the user may select to display the list of patient visits associated with that clinical study. These lists enable the user to review which forms and visits are included within a selected clinical study, prior to reviewing additional details about the selected clinical study. Once the user has identified a clinical study, the user is able to download the current selected study in PDF format for further review.

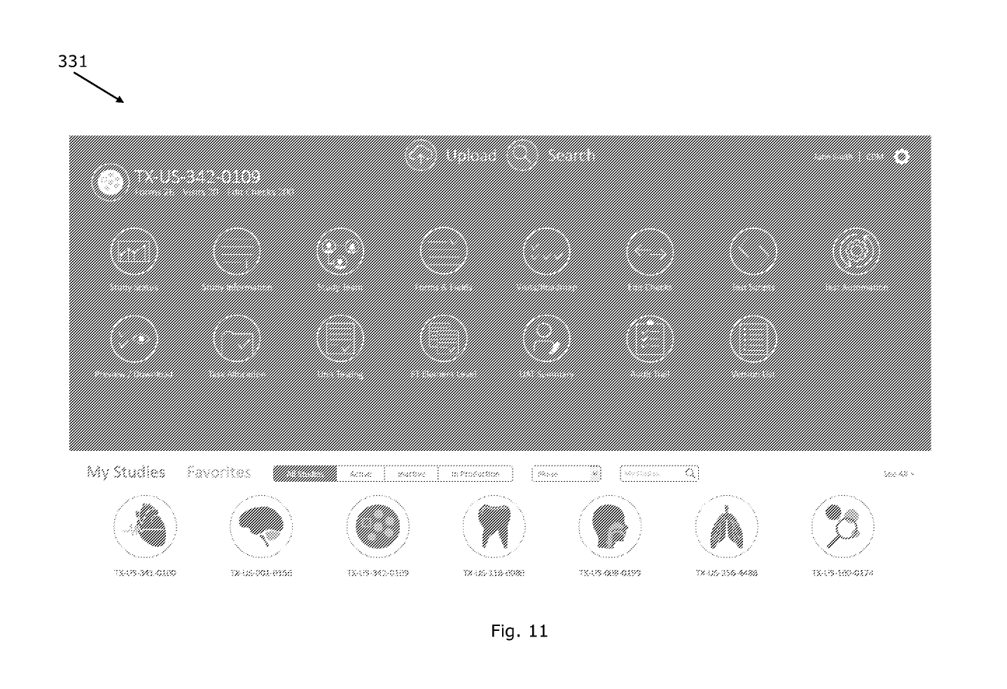

A navigation console screen 331 is shown in FIG. 11. The navigation console screen 331 presents links to features that may be accessed in order to begin building a clinical study or to manage/modify an existing clinical study. Different features may be presented to different users on the navigation console screen 331 depending on the user role and user privileges assigned to the user. Links may be presented to any desired feature, including:

Select/Upload Study—

This feature allows the user, generally a GL or a CDM, to select a clinical study for management, or to create a new study. Creating a new study may be accomplished by selecting an existing clinical study, selecting an existing clinical study template, or uploading a clinical study from a file.

Study Information—

This feature allows the user to review and/or edit the fields on the study information page. If the “Protocol ID/Study ID” field is modified the user may be prompted to approve the creation of a new study.

Study Team (Resource Management)—

This feature allows the user, generally a GL or a CDM, to identify other team members who will participate in one or more aspects of building a clinical study before the clinical study goes live. By identifying other team members, automation of the clinical trial build process is facilitated, and the user may more easily monitor and manage essential components of the clinical study build. When other team members are identified for building a clinical study, those other team members may be automatically notified of their inclusion in the build process. From the point of the initial team member identification, team members may be notified by the system, automatically, when their input or assistance is needed as part of the build process.

Forms and Field—

This feature allows the user to manage the electronic case report forms (eCRFs) and their associated elements and parameters.

Visits/Roadmap—

This feature allows the user to define the patient visits planned as part of the clinical study and associate one or more forms with one or more of the patient visits.

Edit Checks—

This feature allows the user, such as a CDM or EDC Programmer, to define edit check specifications. Each edit check is associated with specific forms and/or fields within a form, and each edit check is configured so that forms and form fields may be tested once a build version has entered the testing stage.

Test Scripts—

In order to verify that the clinical study that has been build is dynamically functioning properly, the system enables a user to create test cases and test scripts. As part of creating test cases and/or test scripts, a user, such as a functional test script writer, the GL, and/or the CDM may set expected results that should come out of the dynamics of the clinical study. The test cases and/or test scripts may then be used to verify the expected results from the build of the clinical study.

Test Automation—

This feature allows a user, such as a functional tester, to generate automated data & scenarios for one or more of the edit checks.

Preview/Download—

The server may allow a user to preview a clinical study being built according to a listing of forms, organized to show the patient visit associated with each form, or according to a listing of patient visits, with each visit showing the associated forms. The server may also offer a user one or more download options for one or more forms associated with a clinical study being built. The download options may include the ability to download one or more forms in various formats, such as in a portable document format (PDF), Architect Loader Spreadsheet (ALS), and Operational Data Model (ODM) format. This feature may also allow a user to generate reports, based on the user role and privileges set for that user role, so that the user may review current information about the clinical study being built and the progress of various activities during the build process of the clinical study.

Task Allocation—

This feature allows a user to allocate tasks to another appropriate user when the one or more parts of the clinical study build is are ready for a next step, the appropriate user allocates them to the user for that step in the process. Automated email notifications may be pushed to an assigned user for the next step.

Unit Testing—

Unit testing may be done and submitted by a user, such as the designated EDC programmer(s). As the user performing the testing starts identifying items as having been programmed and having passed or failed each test, the real-time status of the unit testing can be viewed in the system and/or through reports.

Functional Testing—

Once the unit testing is completed and submitted by the Programmer and/or GL/CDM/FT, the script writer may define test cases so that the functional tester may further perform functional testing on the current build of the clinical study. This further functional testing serves as a form of integration testing to test the current build as a whole. For every test round, the functional tester may specify the testing date, case report form (CRF) version, and test run. The records created by the functional user help the study team to identify how many rounds of testing have been done, on which date and on which published version of the current study build.

UAT Summary—

Once Functional Testing is complete for a given study, the server may automatically trigger the user acceptance testing (UAT) functionality. In case of failed UAT, the server clears the programmed and previous testing “Passed” flags associated with the failed UAT. The designated EDC programmer and functional testers are then tasked with reworking the required activities so that a new round of UAT may be triggered.

In Production—

This feature allows a user, such as the CDM, to mark the clinical study as being “live”, i.e. ready for use. The server preferably allows a clinical study to be marked as live only after all UAT scenarios have been performed and all flags of the testing phase are set to “Passed.” Once the clinical study has been marked as “live,” the server should prevent creation of new testing scenarios.

Audit Trail—

This feature allows a user to see the status of the clinical study build, including identifying which team members have participated in the specific aspects of building the clinical study, so that in the event that issues occur or errors arise within any particular aspect of the clinical study, the team member who worked on that aspect may be easily identified, thereby enabling a more efficient resolution of the issues and/or errors.

Version List—

This feature shows the user a version list of different builds of the clinical study. The version list may label the versions according to the status, such as “Split Go Live,” “Migration,” “Amendment,” or “Full Study Build.” To aid the user in identifying the differences between the different versions, the version list may also include a list of forms and/or patient visits that include differences from an immediately previous build version of the clinical study.

Reports—

The server provides a reporting module which provides the user with reports that are specific to different stages of the build process. The following list of reports that may be provided to the user:
Submission PDF outputs Reports
   Pre-programmed Output Formats—The server may provide pre-programmed reports and report formats from which the user may select during the build steps of the clinical study. Examples include a blank eCRF report, an edit check specification report, an annotated eCRF report, an EDC developer specification, a Study Data Tabulation Model (SD™), and an Analysis Data Model (ADaM), and the like.
   Custom Output Formats—The server may provide a user with an opportunity to design custom reports and report formats. By way of example, the server may allow a user to create a custom PDF output format based on organizational standards.
Unit Testing Report—The server may provide pre-programmed reports and report formats from which the user may select during the unit testing steps. Such reports may include a report showing unit testing submission, unit testing completion, and/or a rejection state level report for the unit testing step.
Functional Testing Report—The server may provide pre-programmed reports and report formats from which the user may select during the functional testing step. Such reports may include a report showing functional testing submission, functional testing completion, and/or a rejection state level report for the functional testing step.
User Acceptance Testing Report—The server may provide pre-programmed reports and report formats from which the user may select during the user acceptance testing step. Such reports may include a report showing user acceptance testing submission, user acceptance testing completion, and/or a rejection state level report for the user acceptance testing step.
Audit Trail Report—The server may provide an audit trail report to a user so that the user may, at any time, identify discrepancies in the build of the clinical study and/or identify a team member who is responsible for or best suited for addressing any error or other issue that may arise.
Version List Report—The server may provide a version comparison report to a user so that the user may identify all differences between any two specified versions of a clinical study build.

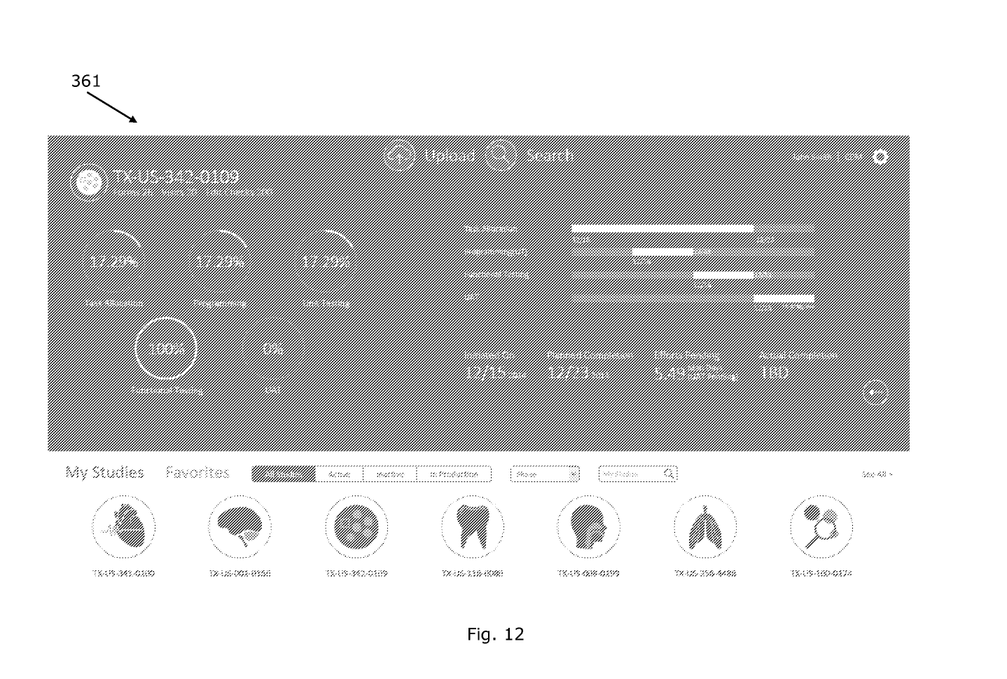

A study status screen 361 is shown in FIG. 12. The study status screen 361 shows the study status build for a selected version of the clinical study. The study status may include all forms, patient visits, and edit checks that are presently incorporated into the selected clinical study build. The study status may also be shown as a graphic so that a user may understand the status of the selected clinical study build at a glance. By way of example, portions of the study status may be displayed as circular progress charts, with each circular progress chart indicating what percentage of the selected clinical study build allocated activities have been completed. Such circular progress charts may include:

Task Allocation—

This circular progress chart shows the percentage of entered forms, visits, and edit checks that have been assigned within the selected clinical study build.

Programming—

This circular progress chart shows, for the selected clinical study build, the allocation of forms, visits, and edit checks that have been identified as ready for programming for unit testing.

Unit Testing—

This circular progress chart shows the percentage of allocated forms, visits, and edit checks that have been identified as having unit testing complete.

Functional Testing—

This circular progress chart shows the percentage of elements which have already undergone unit testing and have also been identified as having functional testing complete.

UAT—

This circular progress chart shows the percentage of elements which have already undergone functional testing and have also been identified as having UAT complete.

By way of another example, portions of the study status may be displayed as Gant charts, with each Gant chart displaying the allocated and completion/submission dates of various assignments.

The study status screen 361 may also display dates relevant to the clinical study, allow the user to change access status for the clinical study, and add comments to the clinical study. For example, the study status screen 361 may display the date the study was initiated and/or the date of planned completion, with the latter being based on the task allocation done by the CDM. The study status screen 361 may also allow a user to mark a clinical study build as restricted to a specific therapeutic area standard only when it is used and/or copied to create a new clinical study. The study status screen 361 may also allow a user to mark a clinical study build to make it accessible at an organizational level, e.g., to others within a business organization. In addition, the study status screen 361 may allow a user to add a comment to the clinical study so that others looking at the clinical study build are able to see the comment.

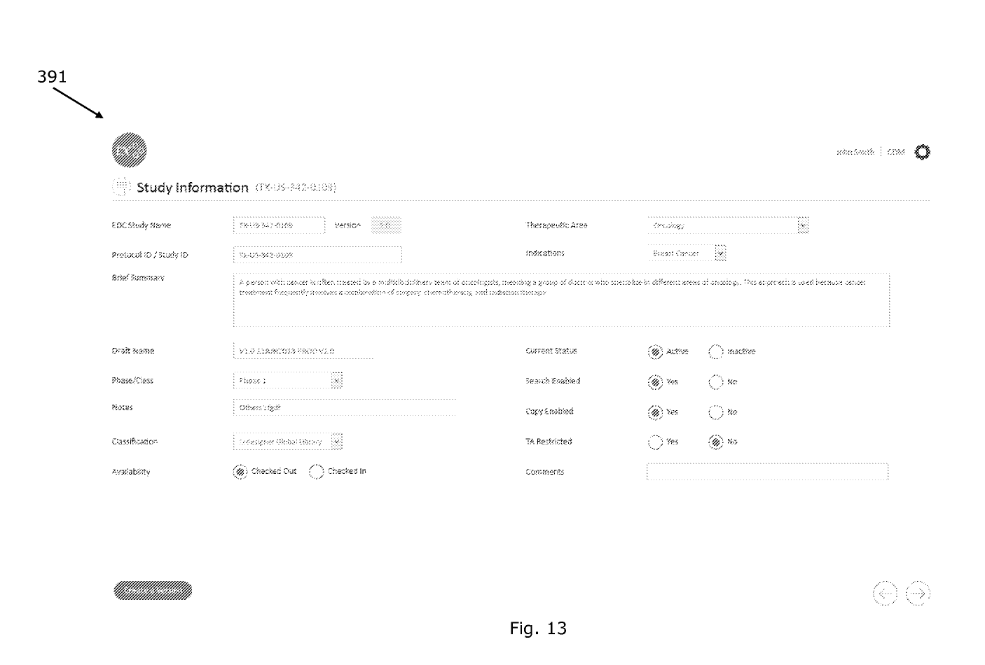

A study design screen 391 is shown in FIG. 13. The study design screen 391 allows a user to set initial parameters at the beginning of the study build process. The information of the study design screen 391 may also be updated throughout the build process. The server may be programmed to prevent a user from making updates to the “Protocol ID/Study ID” field. Instead, a user may use the “create version” button to duplicate the clinical study, thereby creating another nearly identical clinical study, with the only difference being that the server assigns a new “Protocol ID/Study ID” to the new clinical study.

On the study design screen 391, a user having a user role as a GL may see additional database fields for associating data with the clinical study. Such additional database fields are essentially metadata that is associated with the clinical study, and they may include:

Version—

At time of creating a new version, the server is programmed to automatically increment the version so that every clinical study stored by the server is associated with a unique identification number.

Classification—

The user is given the option to label the type of study. Options for labeling the clinical study may include: Global Library, Client Global Library Standard (CGLS), Therapeutic Area Standard (TAS), and Compound Standard (CPS).

TA Restricted—

The user is given the option to mark the clinical study as restricted, with the restriction being placed on the use of the clinical study and copying of the clinical study to the a specific Therapeutic Area Standard.

Availability—

The user is given the option of changing the status of the clinical study/clinical study template to a “Checked Out” or a “Checked In” state. In the “Checked Out” state, the clinical study/clinical study template may be made available to an organization level audience.

Comment—

Here, the user may insert a short description to be added to the clinical study/clinical study template, so that when the clinical study goes live, or it is made available to an organization level audience, other users will see the comment.

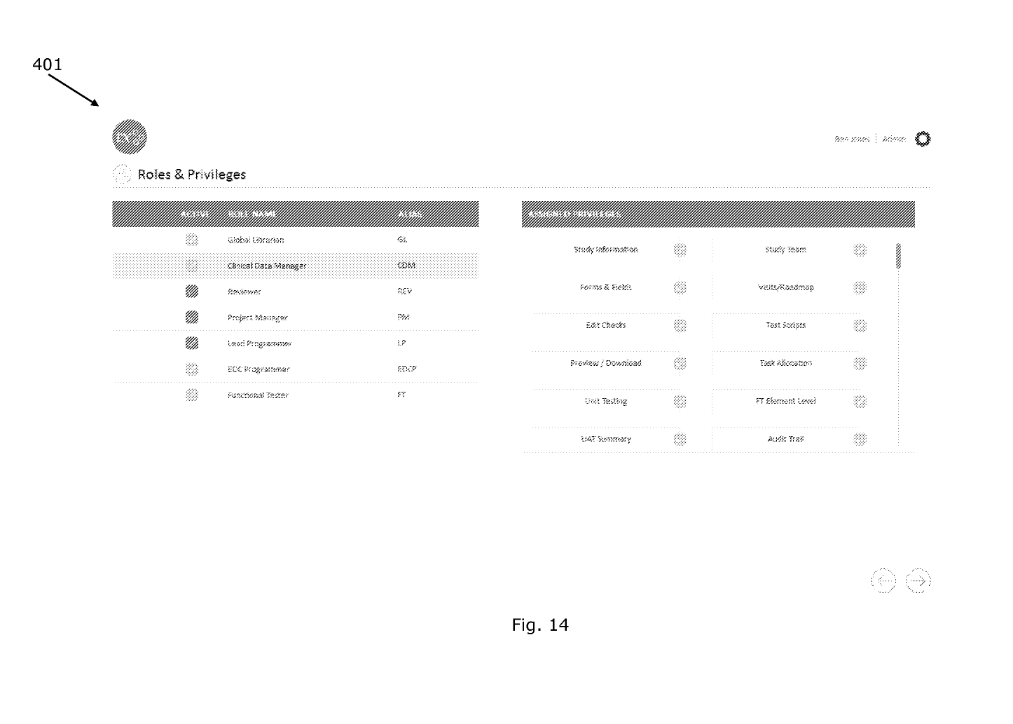

A roles and privileges screen 401 is shown in FIG. 14. The roles and privileges screen 401 allows a user, such as the GL or the CDM, to select which of the user roles are presently active during the build process, and to assign privileges associated with each user role. The general user roles and privileges assigned on the roles and privileges screen 401 may be used later in the build process, by appropriate users, to assign specific roles, tasks, and a workflow for the process of building the clinical study.

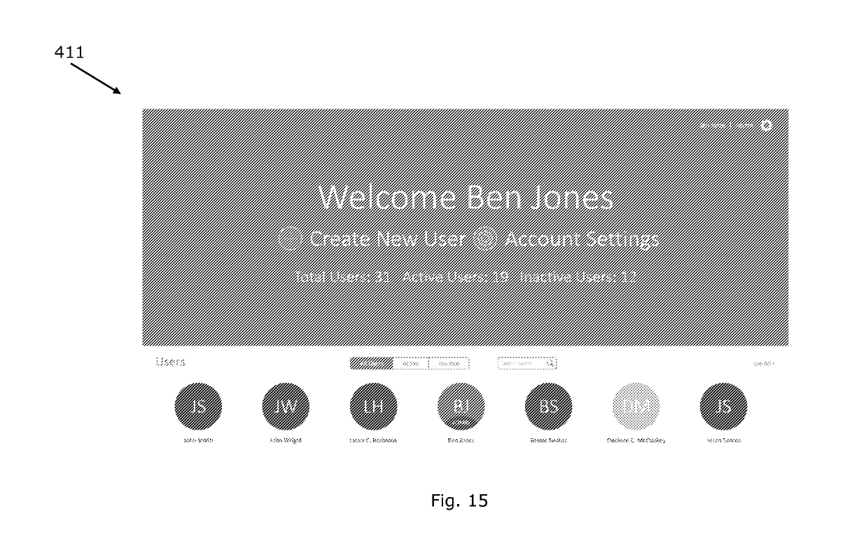

A study team screen 411 is shown in FIG. 15. The study team screen 411 shows a list of users assigned to the clinical study, and each user's user role may also be displayed. Through the study team screen 411 a user, such as the GL or the CDM, may monitor and manage assigned users and the user roles of assigned users for the process of building the clinical study. For example, assigned users may be added, changed, and removed to or from specific roles, so that the GL/CDM may create an appropriate clinical study build team. Other stakeholders of the clinical study build may be informed and aligned in the development process as well. As the process of building a clinical study progresses, the study team screen 411 may be used to identify and assign additional roles to other individuals who have access to the system.

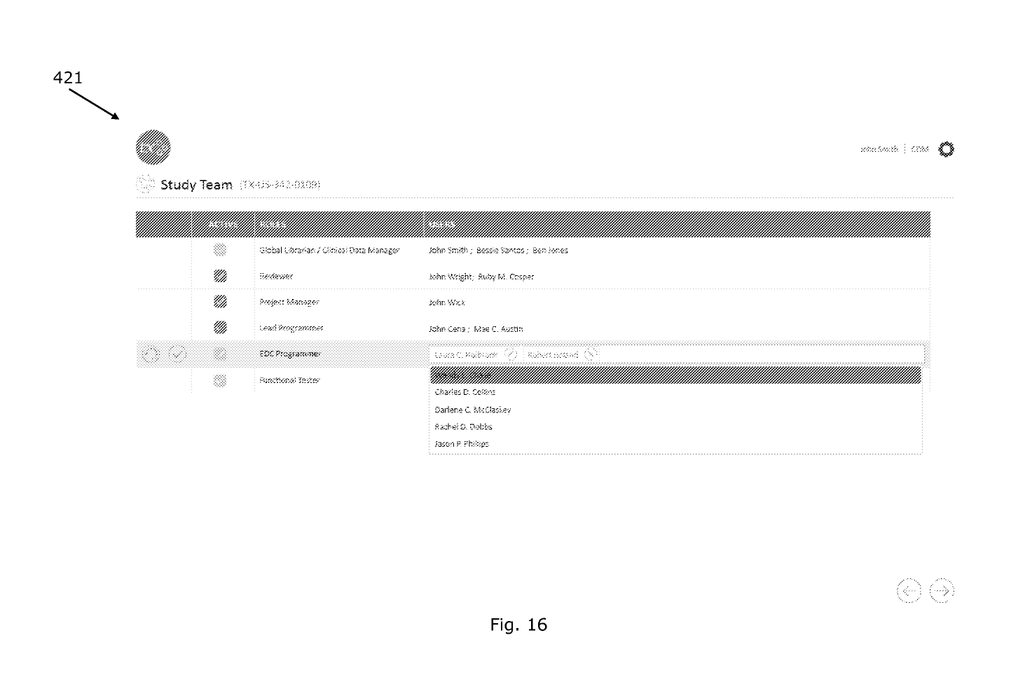

A workflow screen 421 is shown in FIG. 16. Using this workflow screen 421, a user, such as the GL or the CDM, can customize the workflow of building the clinical study by enabling and/or disabling specific roles like reviewer, project manager, and lead programmer roles for the particular clinical study. Once tasks are allocated to the user roles and/or users, the server may prevent those user roles and/or users from be deactivated. The server may also require that the GL, CDM, EDC programmer, and functional tester user roles as mandatory user roles for any building any clinical study, such that these user roles cannot be disabled.

The user roles listed are those drawn from the configuration module, and the server uses the user roles in a sequential methodology to create a customized workflow for the clinical study being built. When a user role is enabled or disabled, the server is programmed to add and/or delete, respectively, that user role from the sequential methodology and to create a specific workflow depending on the protocol or study build requirement in view of the addition and/or deletion of the user role.

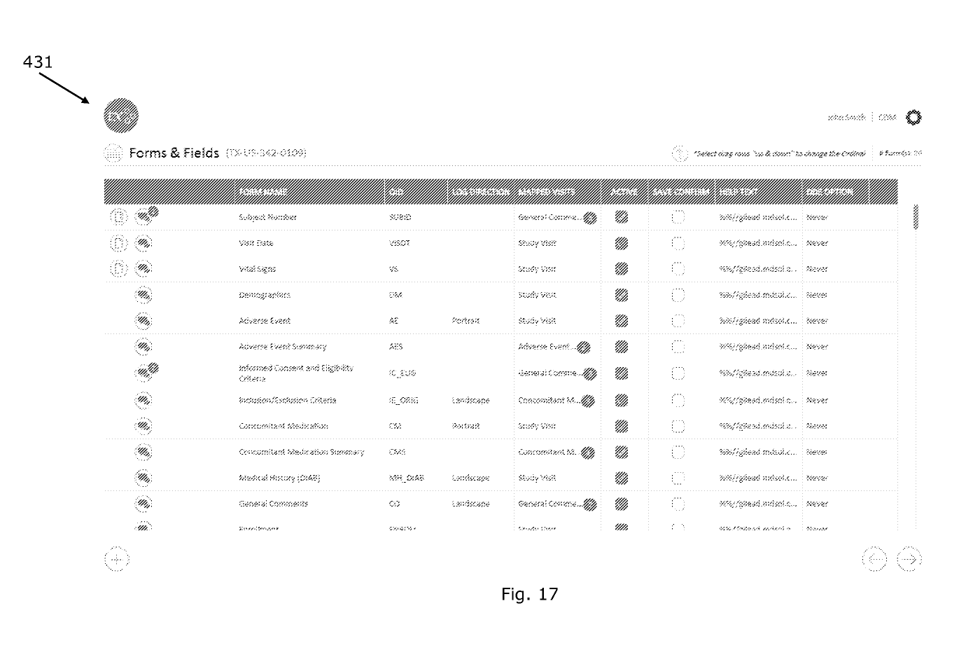

A forms list screen 431 is shown in FIG. 17. The forms list screen 431 lists, for each form, metadata associated with the forms, including:

Form Name—

A unique name that is assigned to each form.

Form OID—

A unique object identifier (OID) that is assigned to each form.

Log Direction—

This indicates whether the form has portrait or landscape orientation for data entry and/or printing purposes, when applicable.

Mapped Visits—

This shows the study visits associated with the Form.

Active—

Whether the form is presently “Active” within the build of the clinical study. The absence of a checkmark indicates an “Inactive” form.

Save Confirm—

This indicates whether form saves by a user (in this case, typically a physician, nurse, or other healthcare worker who sees patients) during the clinical study should be confirmed. When checked, the draft message or confirmation message is displayed at the top of the form when the user saves the form. Save confirm may be checked by default.

Help Text—

This provides text to help with a form. It may also provide a link to help information stored elsewhere, such as a file containing eCRF completion gridlines.

Other metadata may be associated with and/or listed for each form, as desired in a particular implementation. The forms on the form list screen 431 may be sorted or listed in a custom sequence, as determined by the user.

Forms may fall into one of four categories: Active, Inactive, Build, and Unbuild. Active forms are presently included as part of the clinical study being built. Inactive forms are included as part of the build process, but they are not presently mapped to a visit, or they may be mapped and may not be used as the build process finalizes. The Build and Unbuild categories apply only once a clinical study has gone live. “Build”, with respect to a form, refers to a form that has been incorporated as part of a clinical study that has gone live, i.e. the form has been pushed into production. “Unbuild”, with respect to a form, refers to a form that has not yet been incorporated as part of a clinical study that has gone live or to a form that has been removed from a clinical study that is live through database modification.

Through the form list screen 431, forms can be reviewed, added, edited, and deleted by a user according to that user's user role permissions, the user's study assignment, and the study status. The “+” symbol may be used to add a new form. When adding a new form manually the user adds a new form and then enters the metadata information for the new form in the blank row that appears at the bottom of the form list screen 431.

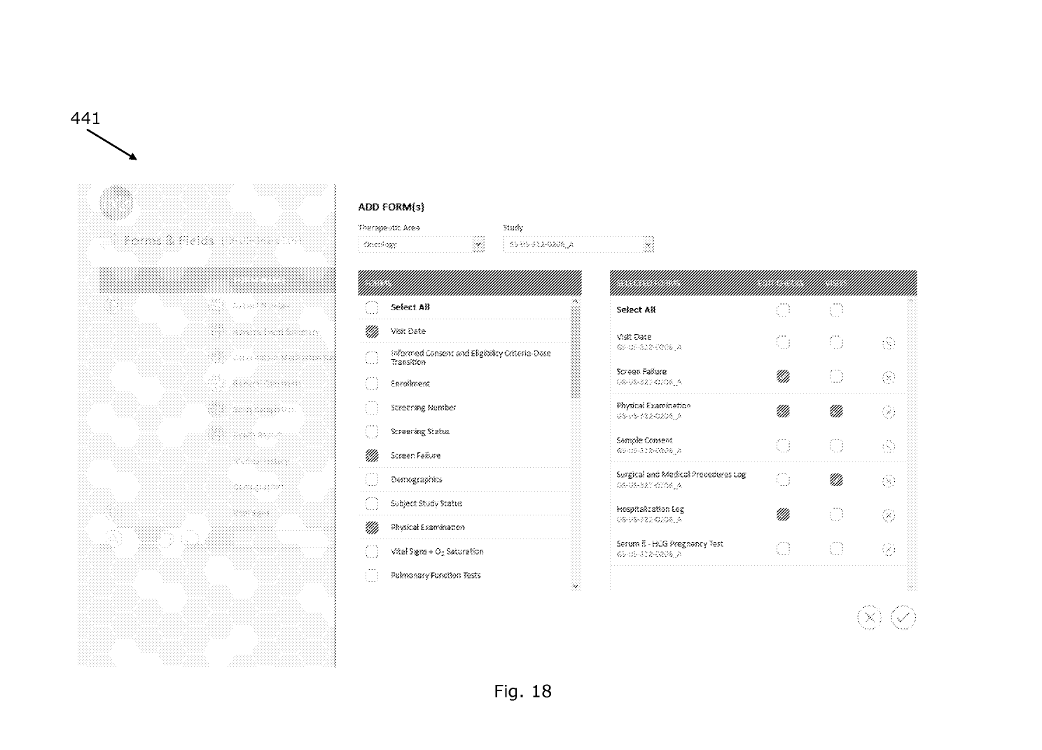

Forms may also be added to the form list screen 431 by importing an ALS or by selecting forms from other clinical studies or clinical study templates. By way of example, a form repository screen 441 is shown in FIG. 18, and using the form repository screen 441, a user may search within other clinical studies and/or clinical study templates to identify forms that are appropriate to copy into the clinical study being built. On the form repository screen 441, the user may elect to search in a therapeutic area and/or a clinical study/clinical study template by use of drop-down boxes. Once a prior clinical study or clinical study template is selected, a list of available forms from the selected clinical study or clinical study template is populated. From the populated form list, the user may select one or more forms to copy into the current clinical study being built. The user may also elect to copy edit checks and/or visits with the forms being copied. The newly copied forms will appear in the end of the list of forms for the current clinical study being built.

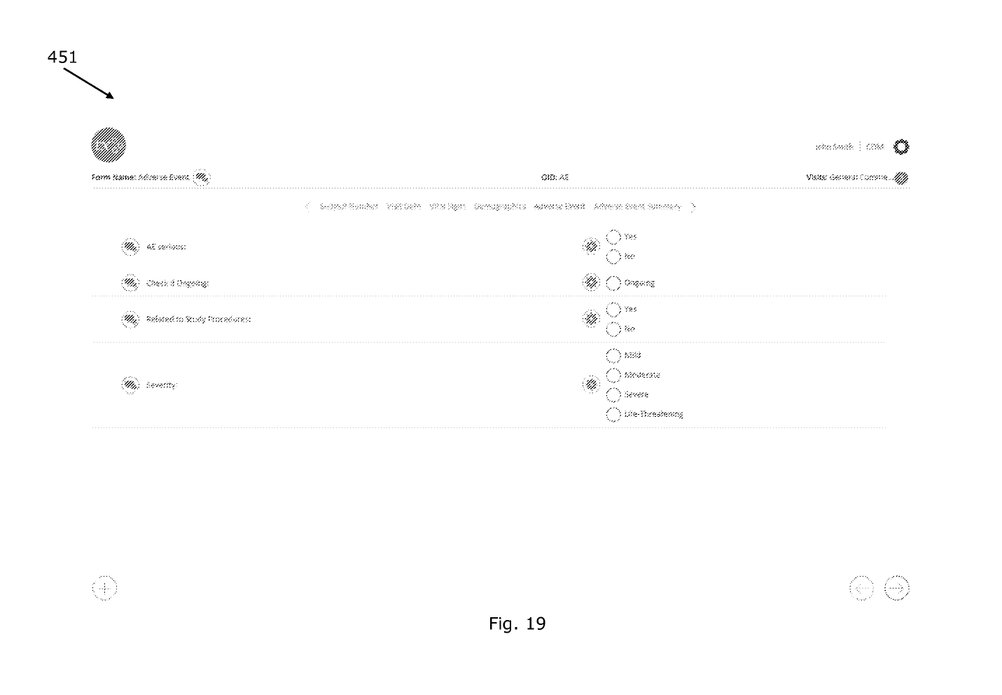

Any of the forms shown on the forms list screen 431 of FIG. 17 may be edited by a user having sufficient privileges. Upon electing to edit a form, the user will see the form edit screen 451 shown in FIG. 19. The form edit screen 451 shows the fields logically associated with the selected form, and the form name, OID, and mapped patient visits appear near the top of the form edit screen 451. The body of the form edit screen 451 lists the each of the associated form fields, displaying a comments icon, which the user may select to add comments associated with the particular form field, the field label, the lists/values icon (if applicable to the form field), which the user may select to add a selectable list/selectable values to the form filed, and a response field for display/confirmation purposes. The response field may not retain information that is entered by the end-user (e.g., the physician or nurse). The user may also add or delete fields from a selected form through the form edit screen 451.

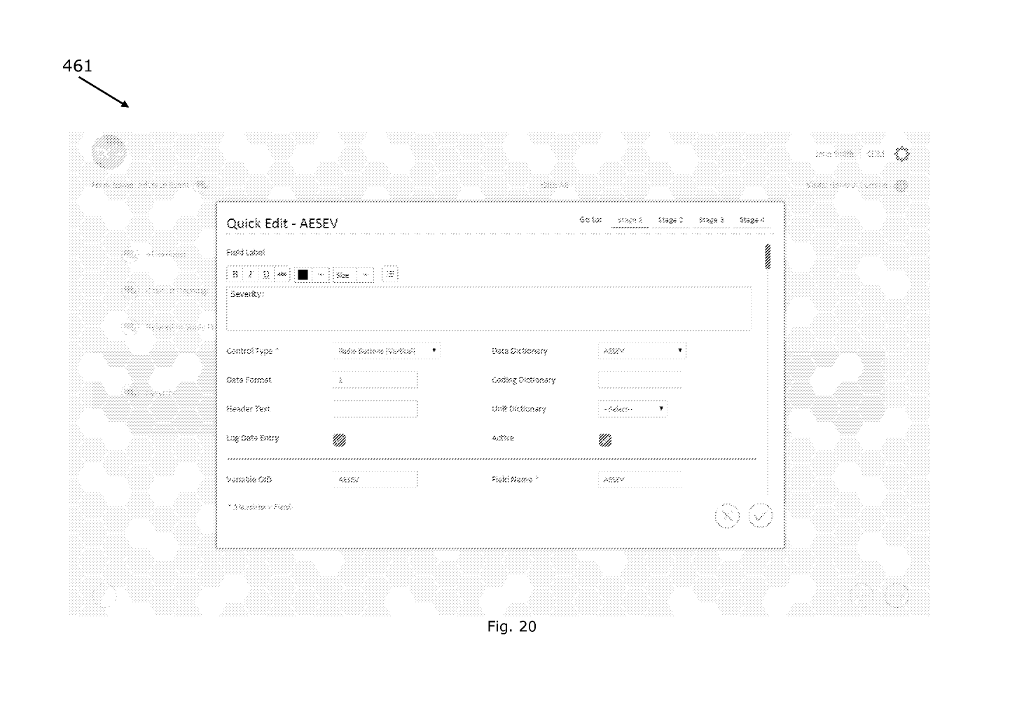

A form field attribute screen 461 is shown in FIG. 20. The form field attribute screen 461 allows a user to create form fields for adding to a form. For each form field being created, the server may require certain field attributes be defined: control type, data format, and field OID. The field attributes are organized into 4 logical stages. The content of these stages may vary depending on the type of electronic data capture (EDC) system that is implemented with the system hosting the clinical study. The EDC system may be integrated with the clinical trial system, or alternatively, it may be a separate system with which the clinical trial system communicates. The stages will contain ODM attributes used across all ODM compliant EDC systems, EDC system specific field attributes, clinical data interchange standards consortium (CDISC) standard attributes, and helpful system specific attributes used for clinical study build design communication purposes. The form field attribute screen 461 includes links to the different stages.

The first form field attribute in Stage 1 is the field label, which is information that appears to the end-user to describe the form field. The field label may be associated with font attributes, such as bold, italic, underline, strike through, color, size, and bullets. More or fewer font attributes may be associated with the field label. The following form field attributes may also be included to define a form field:
SAS Label
SAS Format
CDISC Domain
CDISC Variable
Dynamics
Notes

The above form field attributes are non-EDC-specific field attributes, and more or fewer form field attributes may be available for defining a form field. The specific form field attributes included may be dependent upon the particular EDC System with which the system is being used. In addition, the server may allow a user to add and remove the form field attributes associated with a form field.

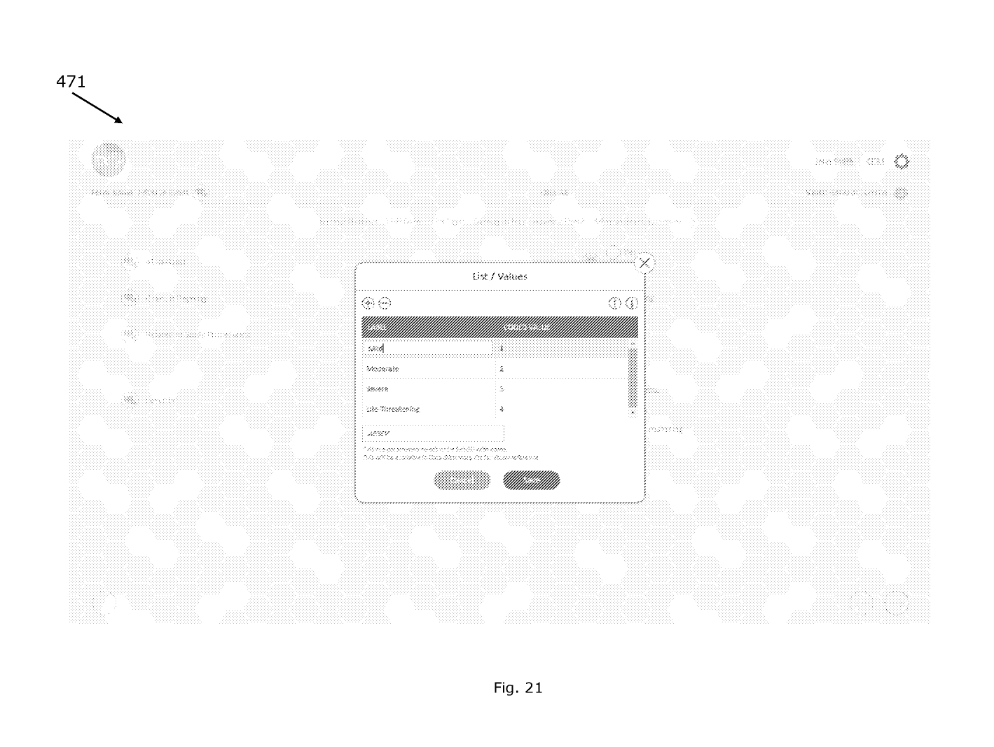

The server may also include a data dictionary/unit dictionary which is globally used throughout the clinical study. The user may enter data directly into the data dictionary/unit dictionary. The server is configured to automatically enter words into the data dictionary/unit dictionary as form fields are defined. For example, FIG. 21 shows a list entry screen 471 that is associated with a form field. When a user enters labels into the list, the server may automatically incorporate those terms into the data dictionary/unit dictionary. In this manner, specialized terms that may be associated with the clinical study will be automatically saved as part of the lexicon of the clinical study. Both the server and the remote devices accessing the server may then utilize this lexicon to the benefit of users, such as through spell checks and speech to text data entry.

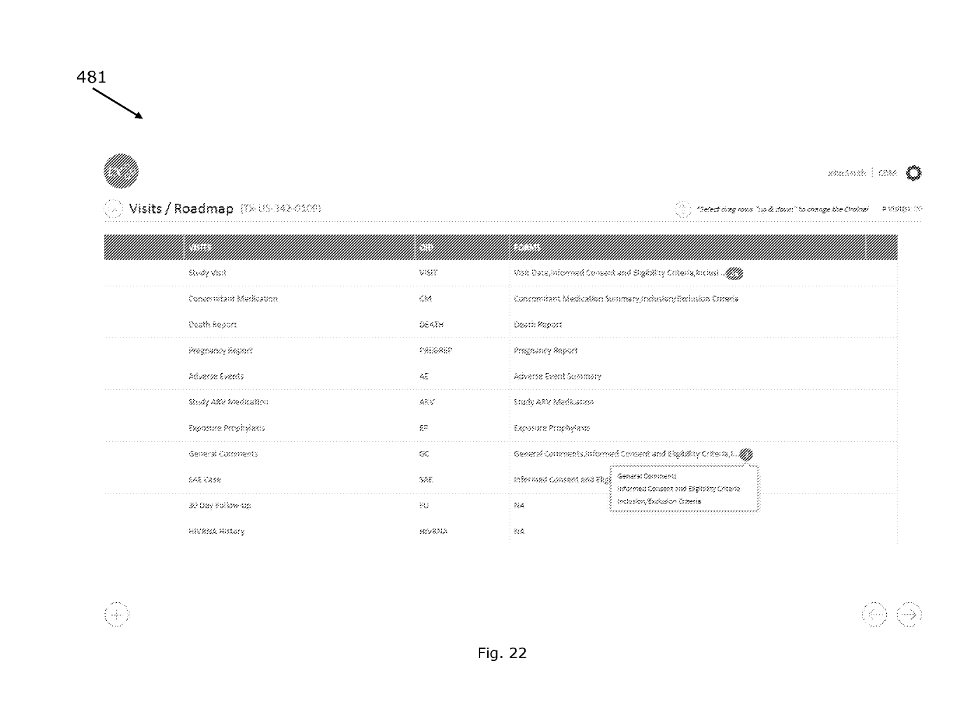

A visits roadmap screen 481 is shown in FIG. 22. The visits roadmap screen 481 lists the patient visits that are presently included as part of the clinical study, and for each patient visit, the following information is listed: the visit description, the visit OID, and the forms associated with the visit. From the visits roadmap screen 481, a user may add, edit, delete, save visits included as part of the clinical study.

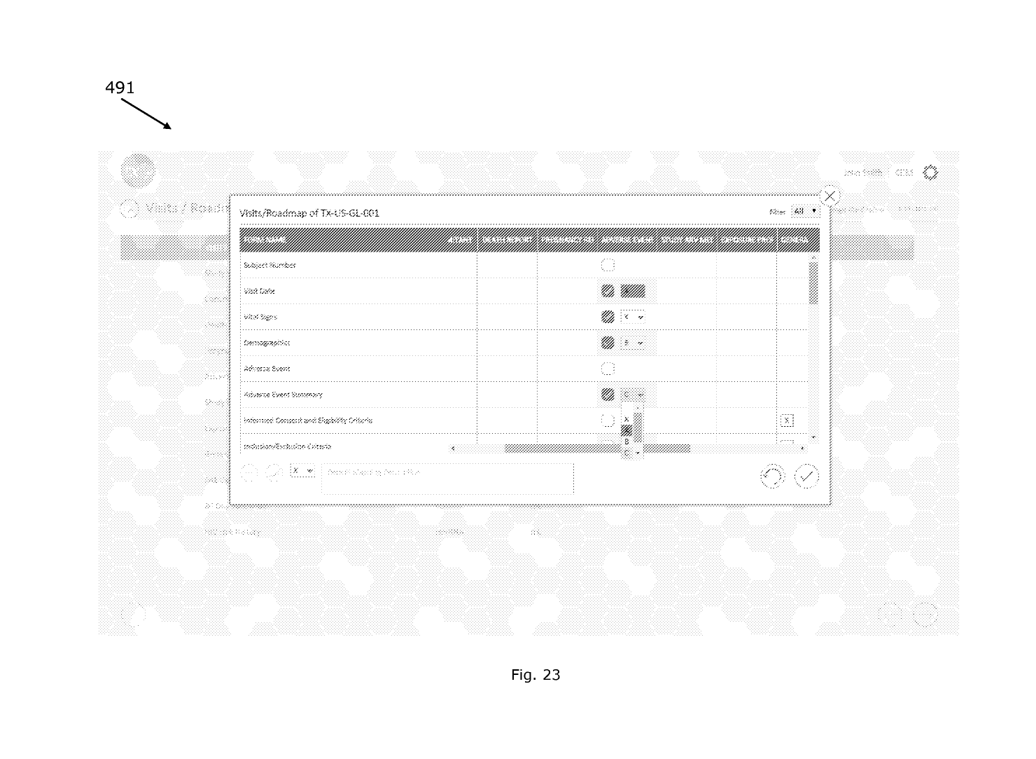

A user may view the overall schedule/table of the visits/roadmap on the visits roadmap screen 481, and the user may manage the mapping for a specific visit by selecting specific visit name on the visits roadmap screen 481, which then takes the user to the mapping screen 491, which is shown in FIG. 23. The mapping screen may also allow the user to filter the visits or view the visits by mapping codes. Through the mapping screen 491, a user may map forms to visits. Multiple forms may be mapped to a single visit, and forms may be mapped to multiple visits. Mapping creates a unique relationship between forms and visits, and the mapping is denoted by an alphanumeric code that is associated with a description/logical condition.

The mapping screen 491 may show all forms associated with the clinical study being built, and those forms which are mapped to the selected visit are indicated with a checked box. For each form checked to be associated with the visit, the mapping screen 491 shows a mapping code. In the example shown, the default mapping code is an “X”, with additional mapping codes of “A”, “B”, and “C” being available. The mapping code indicates the purpose of the form for the visit. For example, “X” indicates collect data form the patient; “A” may indicate information about the visit which isn't medical information about the patient; “B” may indicate data to be collected from the physician; and “C” may indicate a form to be handed or read to the patient. The user may define other mapping codes as desired or applicable for the forms being used with the clinical study being built.

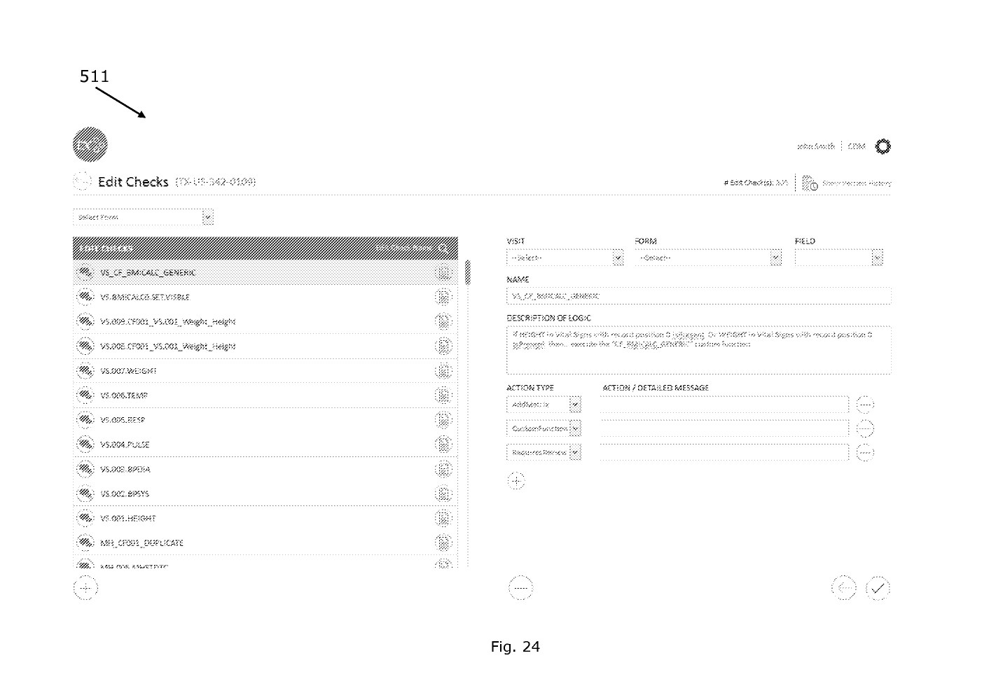

An edit check screen 511 is shown in FIG. 24. Edit checks are associated with forms and fields, and are used for testing the clinical study being built. Edit check specifications identify a condition for programming that may consist of conditions on which a field or a form will be displayed or a query will be generated. The edit check screen 511 allows a user, such as a CDM and/or an EDCP to add, edit, or delete an edit check.

Edit checks listed on the edit check screen 511 may be filtered by form, by source, or by a combination of form and source. The following are three source types that may be identified within a clinical study being built:
Global Library Check
Global Library Check that has been modified
New Edit Check

To filter by form, the user may choose a form from the select form drop-down box. Only all forms or a single form can be chosen. By default all three source types will be listed. To filter by one of them only, a user may click on the representative icon and the other two source types will be hidden. The user may add the other sources back in by selecting the icons for those sources.

A user, such as the GL and/or CDM may also select to define additional actions to be associated with an edit check. To add an additional action, the action is defined in the “Action Types” drop-down list, and the associated “Action/Detailed Message” is also defined. The additional actions may be of any type desired, and they may be custom programmed to achieve a desired action during testing using the edit checks.

Based on the programming status of a clinical study, the edit checks categorized under any of the mentioned filter categories update dynamically. For example, an edit check displayed under the ‘Programming Pending’ category shall be dynamically reflected under the ‘Programming Completed’ category, when an EDC Programmer completes its programming and updates the icon by highlighting it.

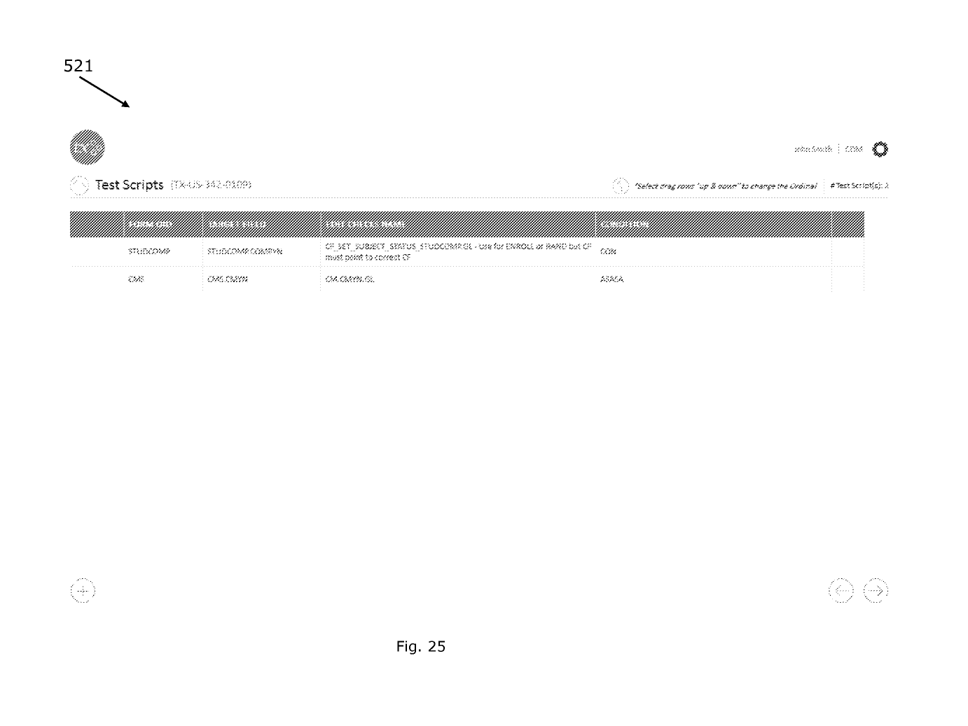

A test script screen 521 is shown in FIG. 25. Test scripts are test scenarios and test cases that use edit checks so that a user, such as a functional programmer or GL/CDM can determine if the current build of the clinical study shows the expected results from a known test cases and/or test scenarios. The test script screen 521 lists tests scripts by the form each test script is associated with, showing the form OID, the target fields to be tested within the associated form, the edit checks being used, and any conditions that are applied by the test script. A user may generate automated data & scenarios for testing one or more of the edit checks associated with forms and/or form fields through the test script screen 521. Also, through the test script screen 521, a user may add, delete, and edit test scripts.

In addition to the edit checks added by a user that are associated with forms and form fields, a user may add edit checks associated with a particular EDC system by uploading a file containing the EDC system edit checks. When EDC system edit checks are uploaded, the server may generate a report identifying discrepancies within the uploaded edit checks indicating whether any discrepancies exist between the uploaded edit checks and the current build of the clinical study.

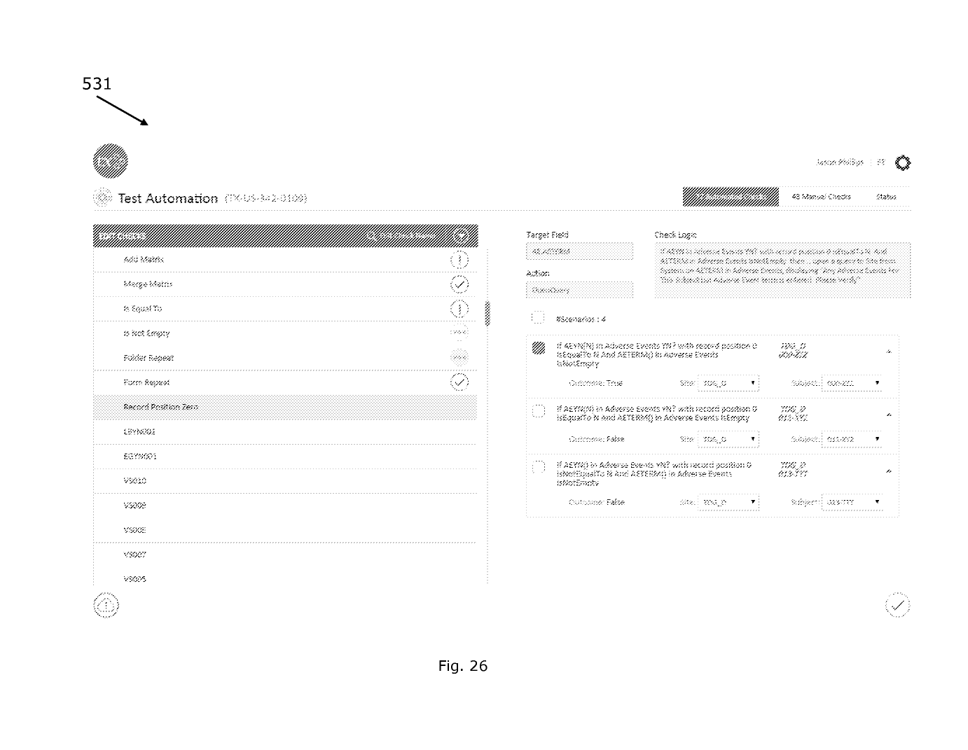

Test automation for a build of a clinical study may incorporate both automated checks and manual checks. A test automation screen 531 for automated checks is shown in FIG. 26. This test automation screen 531 shows a list of edit checks to be applied by a test script, the target field for the script, and scenarios to be applied by the script. At the time the script is run from the test automation screen 531, the various edit checks may be marked by annotation showing a pending edit check, a successful edit check, or an edit check which has resulted in an error.

A test script or test scenario may be system generated based on the uploaded file of EDC system preprogrammed edit checks. Regardless of the source of the a test script or test scenario, all manual and automated test scripts, test scenarios, test cases, and test data may be merged together prior to performance of the functional testing script writing process and functional testing review process.

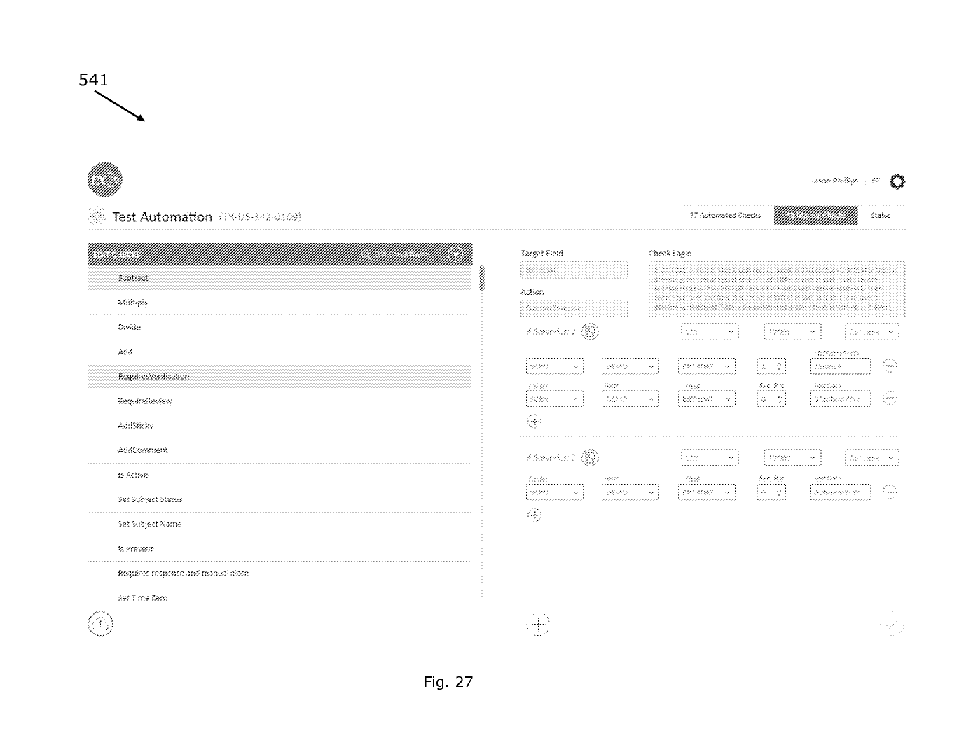

A test automation screen 541 for manual checks is shown in FIG. 27. This test automation screen 541 allows a user to generate custom test scripts on selected edit checks. Using this test automation screen 541, the user may add, edit, and delete scenarios associated with the test script, add, edit, and delete test data and/or test cases, and validate data entry. Optionally, the user may copy existing scenarios from other test scripts to eliminate duplication of effort when a suitable scenario exists elsewhere. The server may run the edit checks associated with the test script, and apply the scenarios, following which the server may report validation of test data right on the screen. By providing validation to a user on the screen, the server will help the user to enter appropriate test data, and it will also save time during the validation.

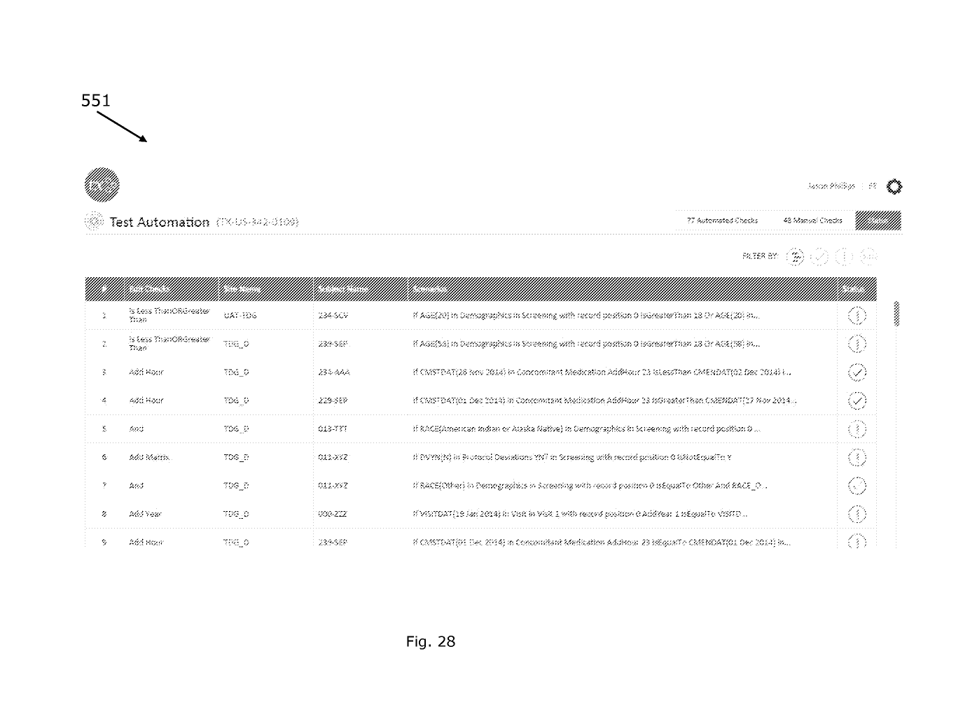

A test automation status screen 551 is shown in FIG. 28. The test automation status screen 551 lists the executed edit checks and associated scenarios. To create this list, the server merges together a list of edit checks from all test scripts, test automation, and test cases that have been executed by the server. This merger may occur at the time of functional testing review. The list indicates whether each edit check is pending, successful, or resulted in an error. For successful edit checks, the list may include a deep link to the associated EDC system so that a user may navigate to the specific results generated by the EDC system.

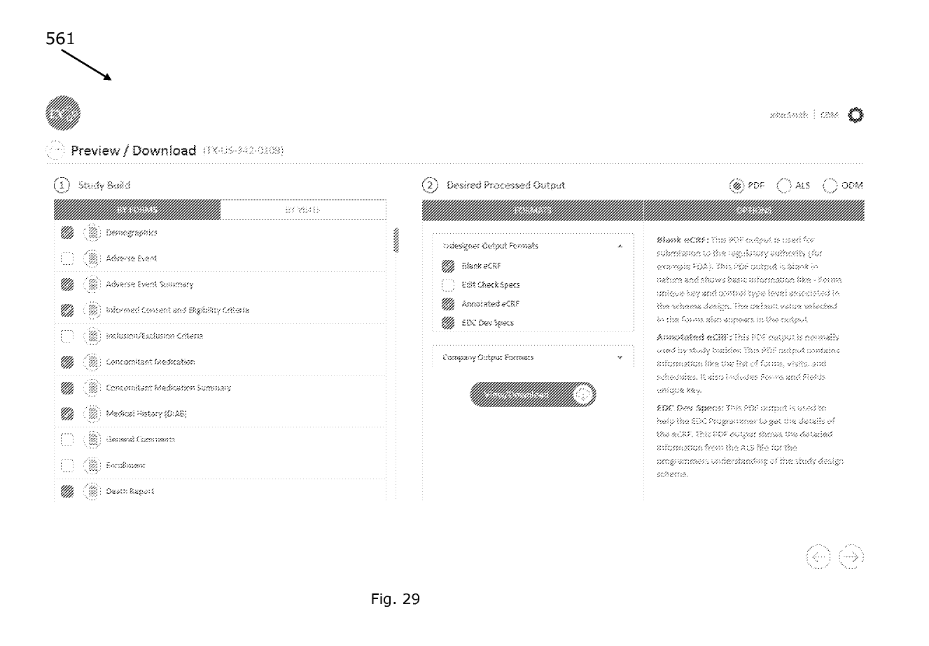

A study preview/download screen 561 with standard outputs is shown in FIG. 29. This study preview/download screen 561 lists all the forms and visits associated with a clinical study being built, without linking to editing capabilities. The server may be programmed to allow only the GL and/or CDM to preview/download outputs for all versions of a study being built, while other user roles may be limited to preview/download outputs for only the most current build of a clinical study. The user may select between listing all the forms associated with the clinical study, or listing all the visits with associated forms. Through the study preview/download screen 561, the user may download processed output in PDF, ALS, and ODM formats. Other formats may also be made available to the user for download. The output format may further be customized by additional selections. For example, when output is selected in PDF format, as is shown in the study preview/download screen 561, the output may be customized by selecting one or more of the following options:

Blank eCRF—

This PDF output customization may be used for submission to a regulatory authority, such as, for example, the FDA. This PDF output is blank in nature and shows basic information, such as the unique key for each of the various forms and control type level associated in the schema design. The default value selected for each form may also appear in the output.

Edit Check Specs—

This PDF output customization is used to output edit checks of forms and form fields.

Annotated eCRF—

This PDF output customization might normally be used by the study builder. This PDF output may contain information such as the list of forms, visits, and schedules. It may also include the unique identification associated with each form and each form field.

EDC Dev Specs—

This PDF output customization may be used to help an EDC programmer get the details underlying an eCRF, those details contained in the developer specifications (Dev Specs). This PDF output may show the detailed information from the ALS file so that a programmer may see and better understand the study design schema.

SD™ eCRF—

This PDF output customization is an enhancement over the blank PDF. Additional fields may be added in the Blank PDF for the SD™ eCRF output. When additional fields are added, they may appear with different font sizes, colors, and backgrounds in the associated fields and forms, and they may contain additional or multiple annotations.

Select All—

Select all will download all the format customizations as “ZIP” file format

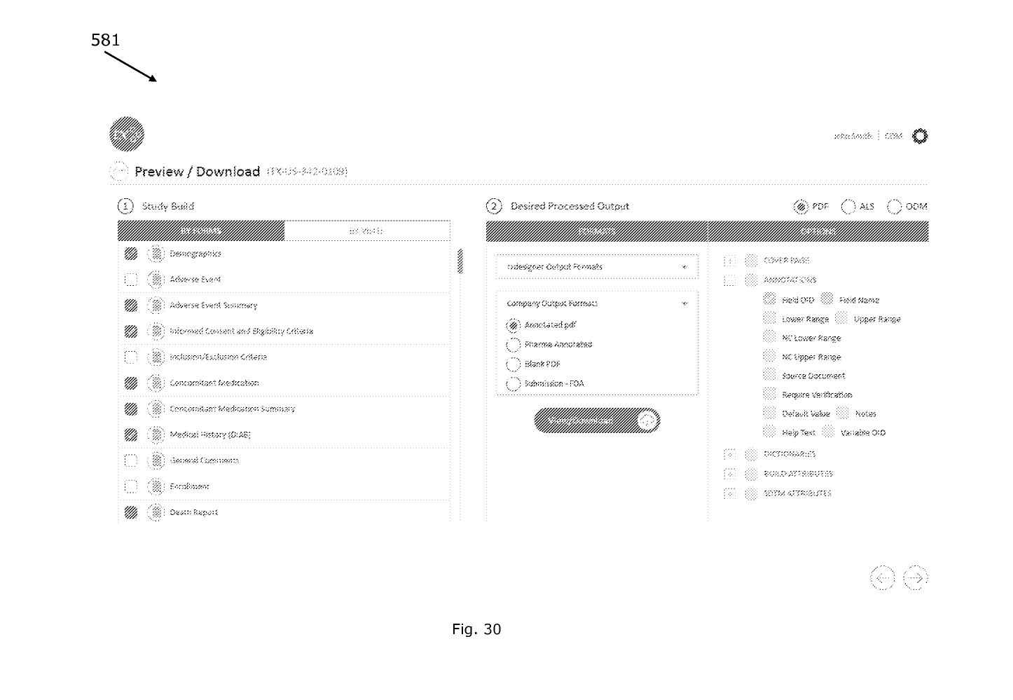

A study preview/download screen 581 with customized outputs is shown in FIG. 30. This study preview/download screen 581 lists all the forms and visits associated with a clinical study being built, without linking to editing capabilities. The user may select between listing all the forms associated with the clinical study, or listing all the visits with associated forms. Through the study preview/download screen 581, the user may download processed output in PDF, ALS, and ODM formats, and each of these formats may include additional format customization options. These customization options may be configured for each specific organization implementing the system. Different custom attributes for each format option shown on the study preview/download screen 581 may also be made available. Optionally, the user may be given an option to change default custom attributes, depending upon the implementation.

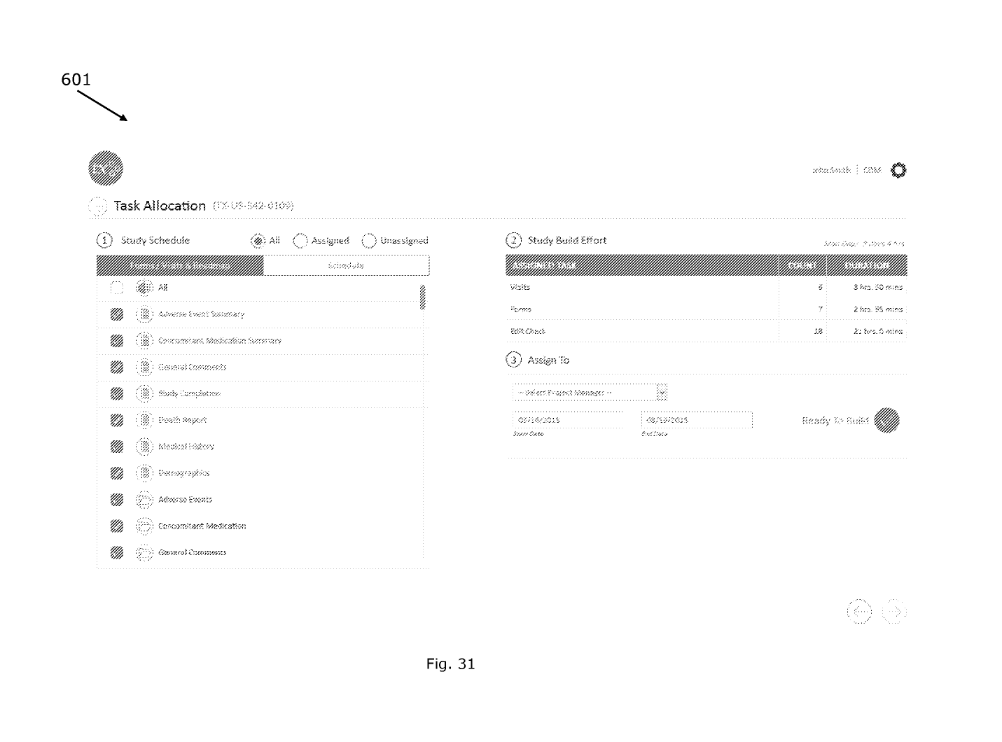

A task allocation screen 601 is shown in FIG. 31. The task allocation screen 601 allows a user, such as a GL and/or CDM to assign tasks to user roles which are active for the clinical study build. Based upon the assignment of tasks to user roles, the server will build a workflow for building the clinical study. Once the study workflow is build, as the workflow progresses, and different additional tasks arise, then the user in the role overseeing those tasks will be asked to assign the additional tasks to users having other user roles. By way of example, the lead programmer may assign additional programmers and/or testers as additional tasks relating to programming and testing arise. As user roles and tasks are assigned, forms are selected, edit checks are created, and the build roadmap begins to fill out, the server will compile benchmarks for building the clinical study. The benchmarks may be shown on the task allocation screen 601, and may include the estimated time of completion for the different major categories of work within the clinical study build. The benchmarks may be in part based upon the start date and end date set by the GL/CDM and by specifications that are particular to an organization using the system. In addition, the benchmarks are generally a suggestive time range that is generated by the system, and the algorithm used to suggest the benchmarks may be adjusted as an organization learns more about use of the system for building a clinical study.

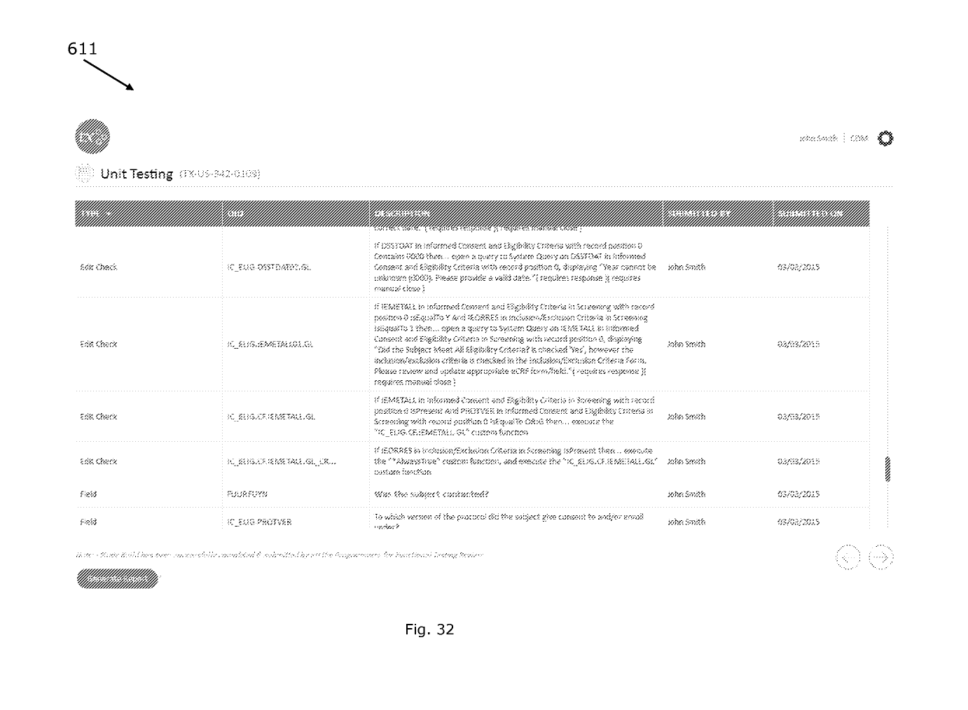

A unit testing screen 611 is shown in FIG. 32. The unit testing screen 611 lists units within the build to be tested, e.g., a visit, a form, a form field, or an edit check, the object ID for the each unit, a description of each unit, a user responsible for each unit, and the date on which the unit was submitted. Additional details may also be included in the list for the unit testing screen 611. The unit testing screen 611 may also show the current status for each unit within the current build of the clinical study, such as whether the unit represents a completed task, whether programming has been completed for the unit, whether testing has begun, and whether the unit has passed or failed unit testing. Once a unit has passed unit testing, it may be made available for functional testing. The server may also make a unit testing report available through the unit testing screen 611.

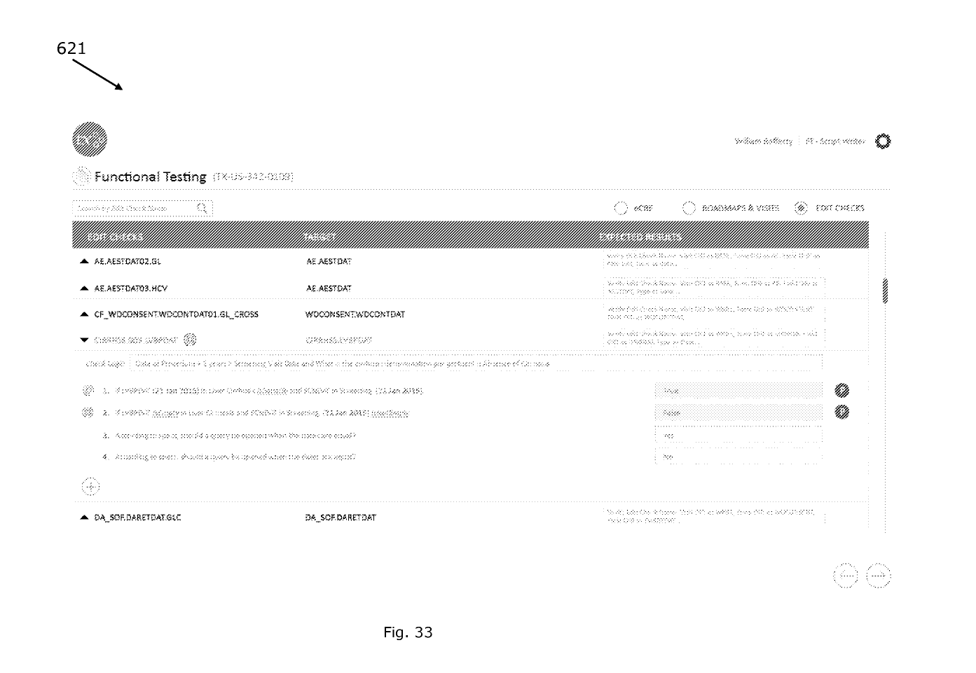

A script screen 621 for functional testing is shown in FIG. 33. Once the current build of the clinical study is ready for functional testing, a script writer may start writing the test scripts that are an integral part of functional testing. Functional testing servers to test that the clinical study produces the expected output based upon the input of defined test cases. By using test cases for the functional testing, the scripts used for the testing are able to validate the dynamics of the current build of the clinical study. This testing therefore tests the forms, form fields, and edit checks that form the basis of the database underlying the clinical study. The server may merge auto-generated test cases with manually generated test cases to perform the functional testing.

A user may elect to show different categories of items that need functional testing on the script screen 621, such as the eCRF (study forms and form fields), roadmaps and visits (visits, forms, and logical mappings), and edit checks. A list of edit checks are shown on the script screen 621, and for each edit check, the list includes the name of the edit check, a file or location from which the test data is drawn, and the expected results for the test script after testing each edit check. The server may show a user further details associated with the test script programmed for each edit check, the details including the description associated with the test script, the test scenarios associated with each test script, and the status of each test script. The server may also show the status of each test scenario, indicating the results of each test scenario and whether the edit check passes or fails the test scenario.

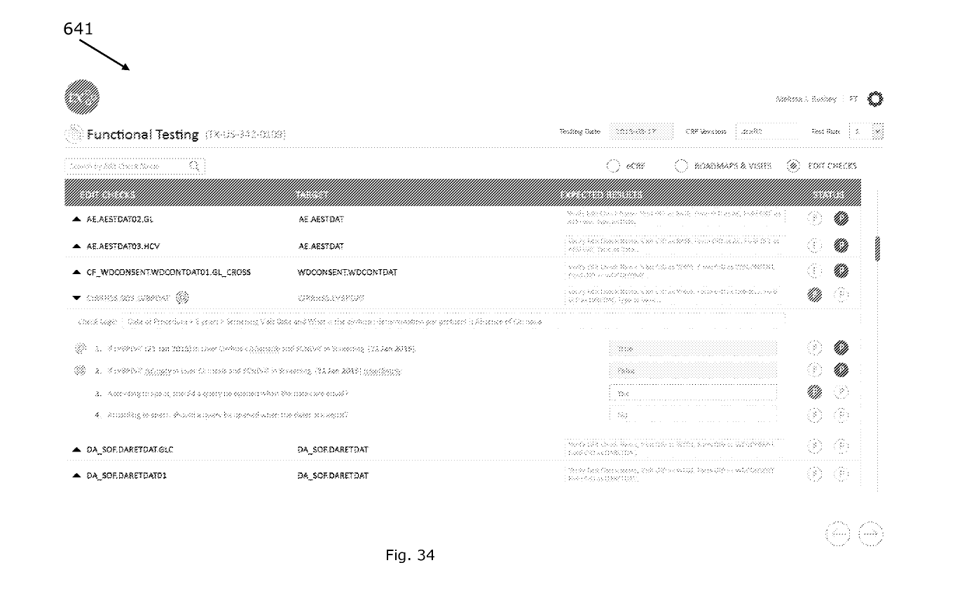

A functional testing screen 641 is shown in FIG. 34. From this functional testing screen 641, a functional tester may perform a round of testing on the current build of the clinical study. The functional testing screen 641 may show much of the same information that is shown on the script screen 621. In addition, for every round of functional testing, the functional tester is asked by the server to specify the testing date, CRF version, and the test run. Having this information will help the study team to identify how many rounds of functional testing have been done, on which date, and on which build version of the clinical study.

To complete functional testing, testing should be performed on each grouping of the eCRF (study forms and form fields), roadmaps and visits (visits, forms, and logical mappings), and edit checks. All elements in each group must pass before the build of the clinical study is passed on to unit testing. At the completion of functional testing, the server may generate a functional testing report showing information on the various rounds of functional testing.

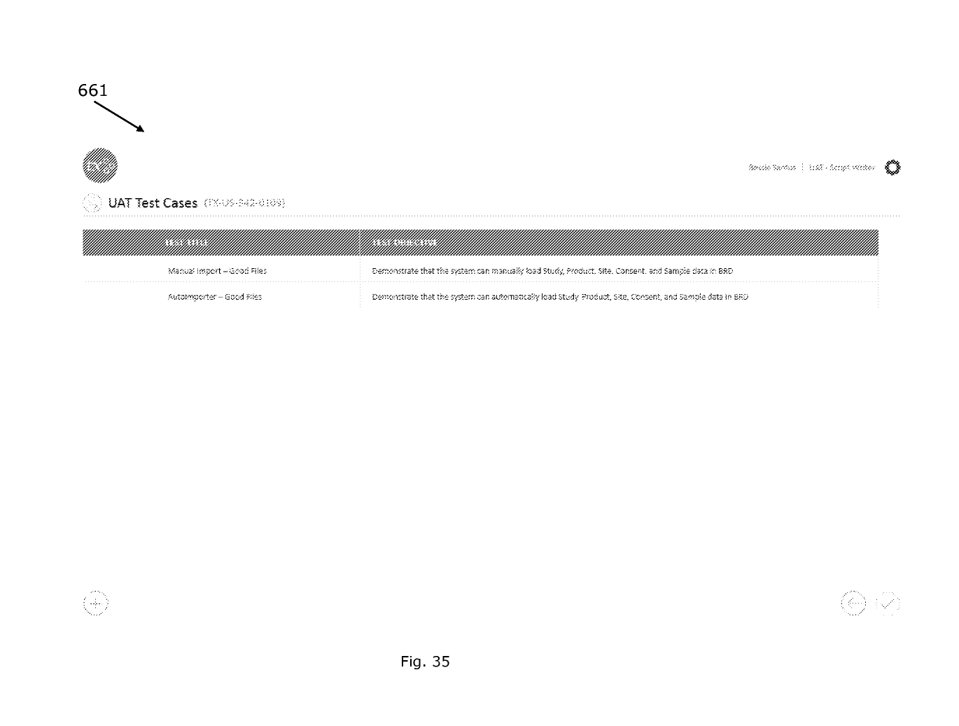

A UAT test case list screen 661 is shown in FIG. 35. This UAT test case screen 661 lists UAT test cases, and for each UAT test case, includes the title and a short description. Through the UAT test case list screen 661, a user, such as a script writer, may add, delete, and edit UAT test cases. Each UAT test case includes one or more test cases and/or test scripts developed by a script writer and based on the clinical study build protocol specifications and the expected results. Each UAT test case may also include instructions for carrying out testing of the current build of the clinical study. User acceptance testing serves as the final round of testing before a clinical study is pushed live, and all UAT test cases should be completed with “passing” results before the clinical study is pushed live.

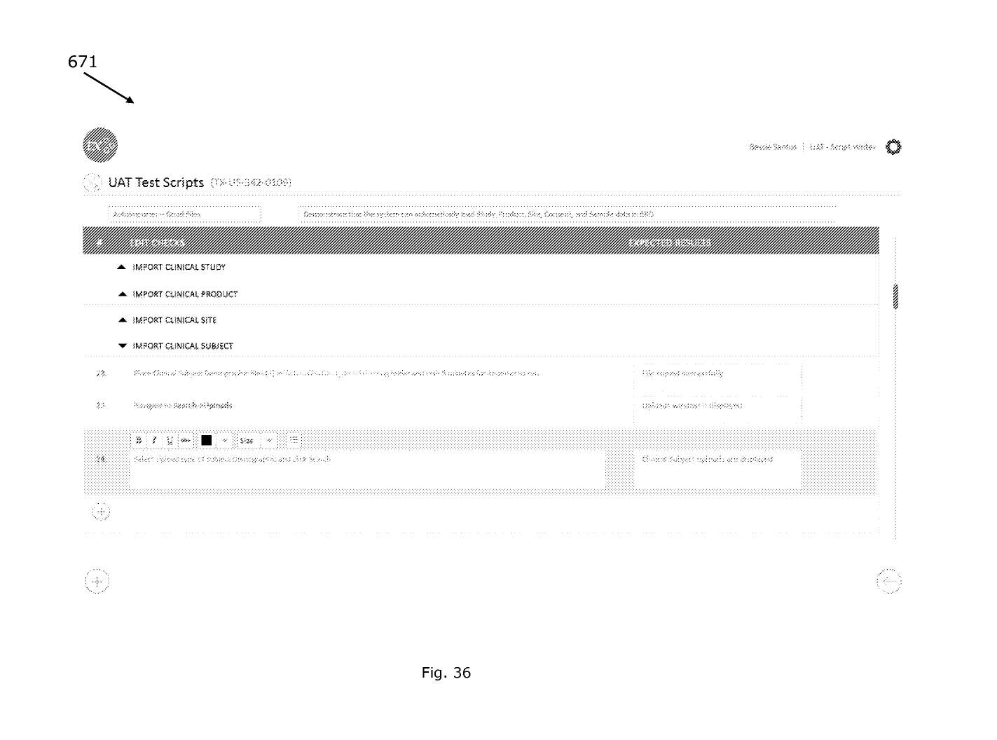

FIG. 36 shows a UAT test case edit screen 671 by which a script writer may import test scripts, test scenarios, and edit checks into the UAT being edited, each test script, test scenario, and edit check forming one of the steps defined within the UAT test case. In addition, the script writer may input step-by-step instructions to accompany each step of the UAT test case, along with the expected results for each step of instructions. As shown, each step of the UAT test case may be accompanied by multiple steps of instructions and expected results. The instructions serve to guide a UAT executor through the testing process.

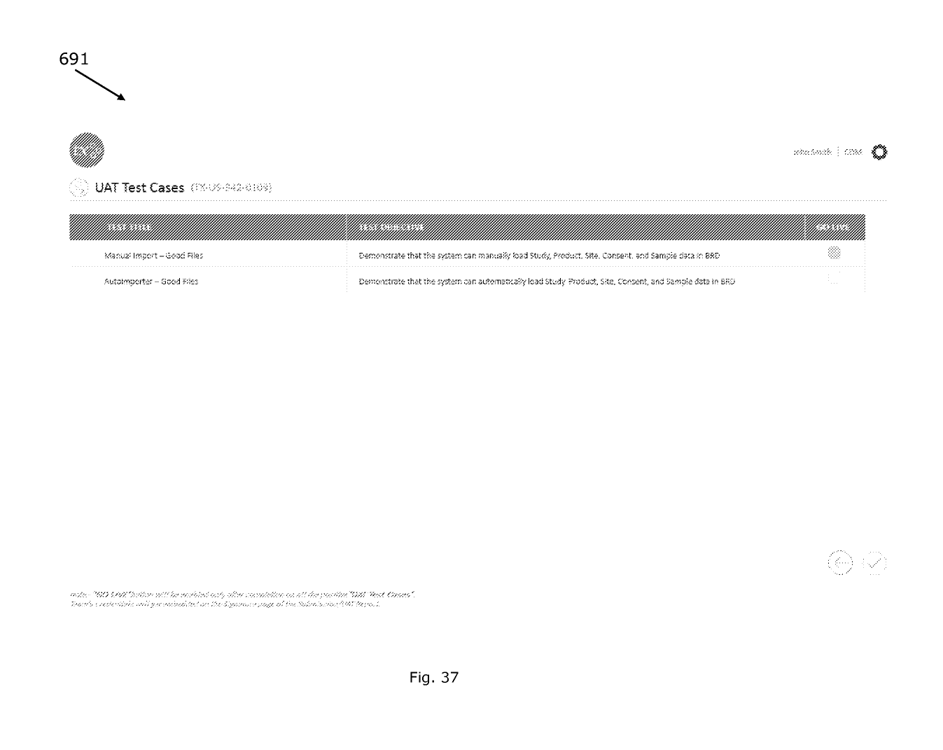

Once the UAT test cases are developed, then a UAT executor follows instructions for implementing the UAT test cases to determine whether the desired output is achieved from the current build of the clinical study. A second UAT test case list screen 691 is shown in FIG. 37. This UAT test case screen 691 lists UAT test cases, and for each UAT test case, includes the title and a short description. Through the UAT test case list screen 691, a user, such as an UAT executor, may access the listed UAT test cases for performing user acceptance testing.

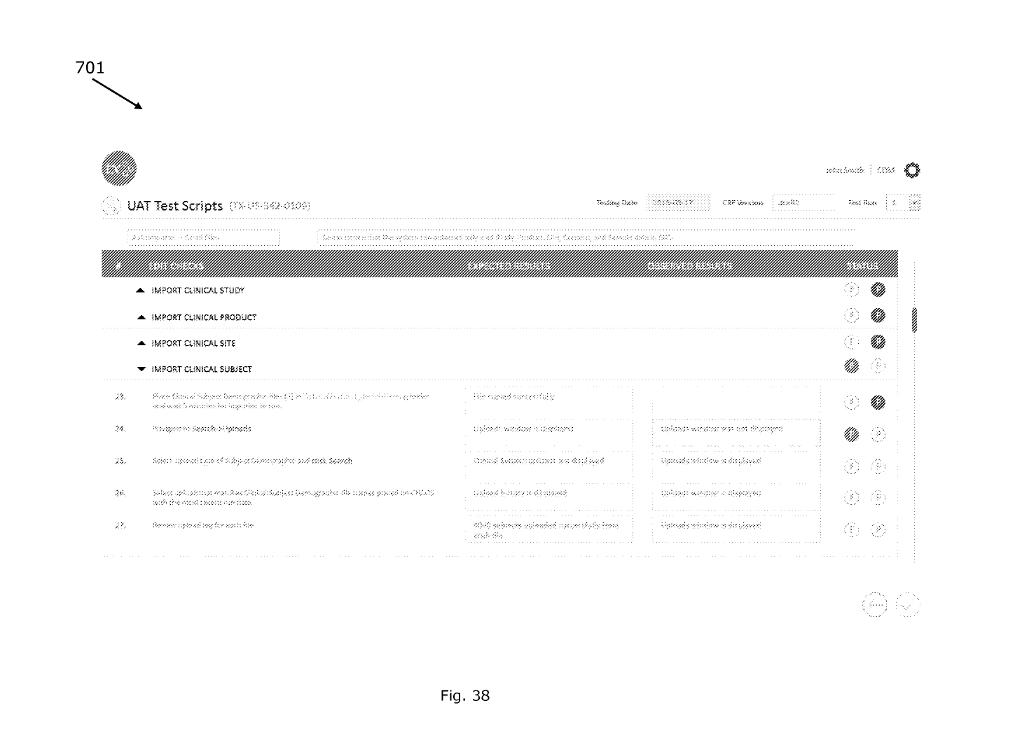

A UAT test case execution screen 701 is shown in FIG. 38. Through the UAT test case execution screen 701, a user, such as a UAT executor, may perform user acceptance testing by executing test scripts, test scenarios, and edit checks associated with a UAT test case. The UAT executor is tasked with completing the test scripts for each UAT test case, by following the instructions provided, determining whether the output form the test scripts matches the expected output, and then marking each test script as “Pass” or “Fail.”

When an issue arises due to a script marked as “Fail”, the server may automatically direct a task for correction of the issue giving rise to the test failure to a specific user and/or user role based upon previously assigned/allocated tasks during the build process for the clinical study. In this way, the server efficiently allocates resources, so that the issue may be addressed by the appropriate user. The step-by-step processing of scripting aids the server in identifying the source of the issue. For example, if the issue is related to the protocol specification, the server may direct a task, with automatic notification, to the GL, the CDM, and/or an appropriate reviewer, with the task identifying the specific form, visit, or edit check giving rise to the issue. If the issue is related to programming, the server may direct a task, with automatic notification, to the EDC programmer, with the task identifying the specific form, visit, or edit check giving rise to the issue. If the issue is related to testing, the server may direct a task, with automatic notification, to the Functional Tester, with the task identifying the specific test case, test scenario, test script giving rise to the issue.

UAT may be considered complete when it meets all the requirements in the protocol specifications for the clinical study. Additional requirements may be defined as needed or desired for a clinical study build, whether or not such additional requirements are incorporated into the protocol specifications.

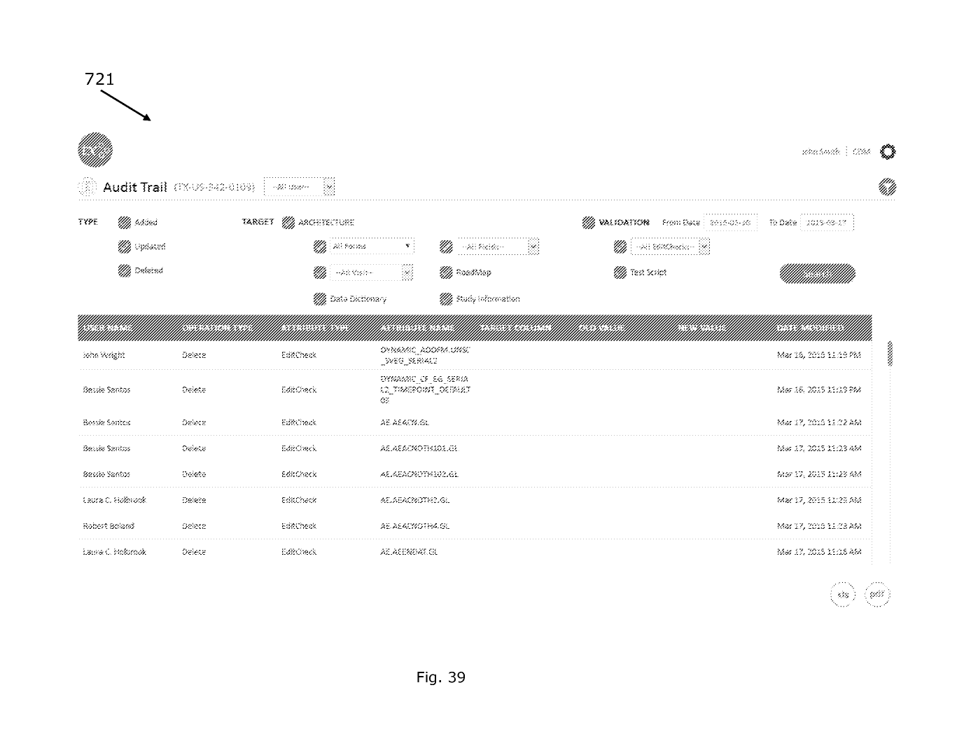

An audit trail screen 721 is shown in FIG. 39. The audit trail screen 721 lists information that is automatically generated by the server when users add, delete, or change any part of the clinical study being built, and the audit trail screen 721 may be viewed at any time. Preferably, the server tracks each and every activity done during the build process for a clinical study to display on the audit trail screen 721. For purposes of the audit trail, the server tracks the changes and identifies changes that are made, so that on the audit trail screen 721, a user may see an element (e.g., a form, a form field, an edit check, and other parts of the clinical study build) before a modification is made and after the modification is made. The server also tracks the user who made the change, along with the date and time the modification was made. A user accessing the audit trail screen 721 is given the option to filter the type of information shown on the screen by selecting/deselecting one or more of the checkboxes above the list. The audit trail, with all the details it includes, plays an important role that enables a user to identify any discrepancies and/or identifying the user who is responsible for errors or issues that arise.

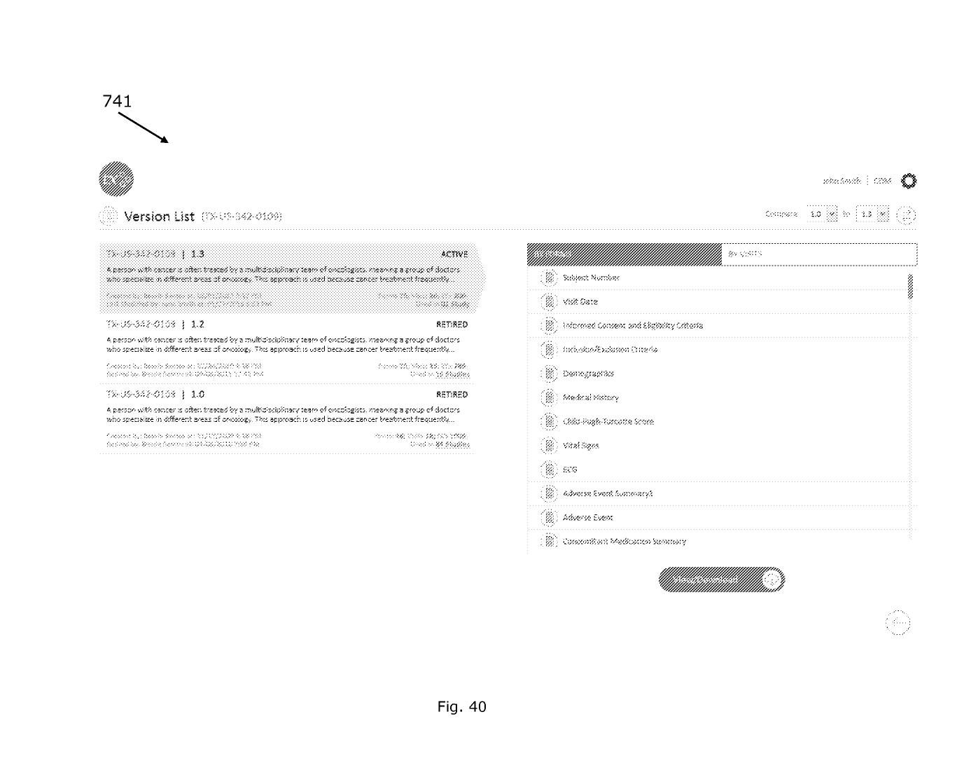

A version list screen 741 is shown in FIG. 40. The version list screen 741 lists different versions of the clinical study build, and through this screen, a user may select one of the versions to see a list of the forms or a list of the visits with associated forms. The listing for each version of a clinical study may include information such as, the date created, the date modified, the date retired, the number of forms, the number of visits, the number of edit checks, and any other information that may be desirable to list. From the version list screen 741, a user with sufficient privileges may download or view additional details about a selected version of the clinical study.

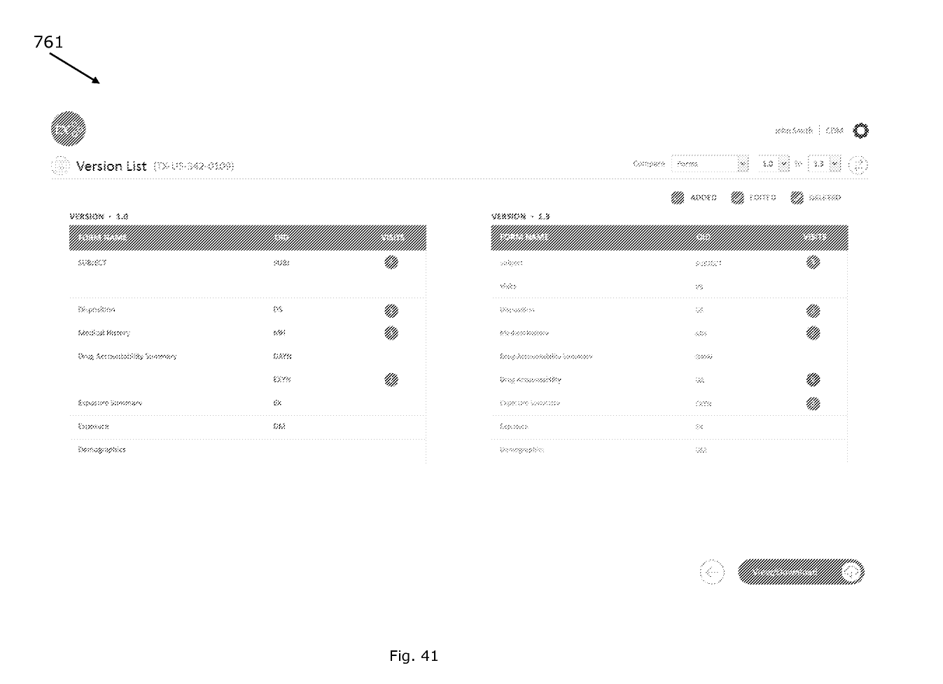

The version list screen 741 also allows a user to compare different versions of the clinical study. A version compare screen 761 is shown in FIG. 41. When two versions of a clinical study are selected for comparison, the server will display to the user the differences based on what has been added, deleted, and edited in a second selected version of the clinical study as compared to a first selected version of the clinical study. In addition, the server may allow a user to see a list of changes to specific forms, visits, and edit checks. Finally, through the version list screen 741, a user is able to download a report showing the version comparison.

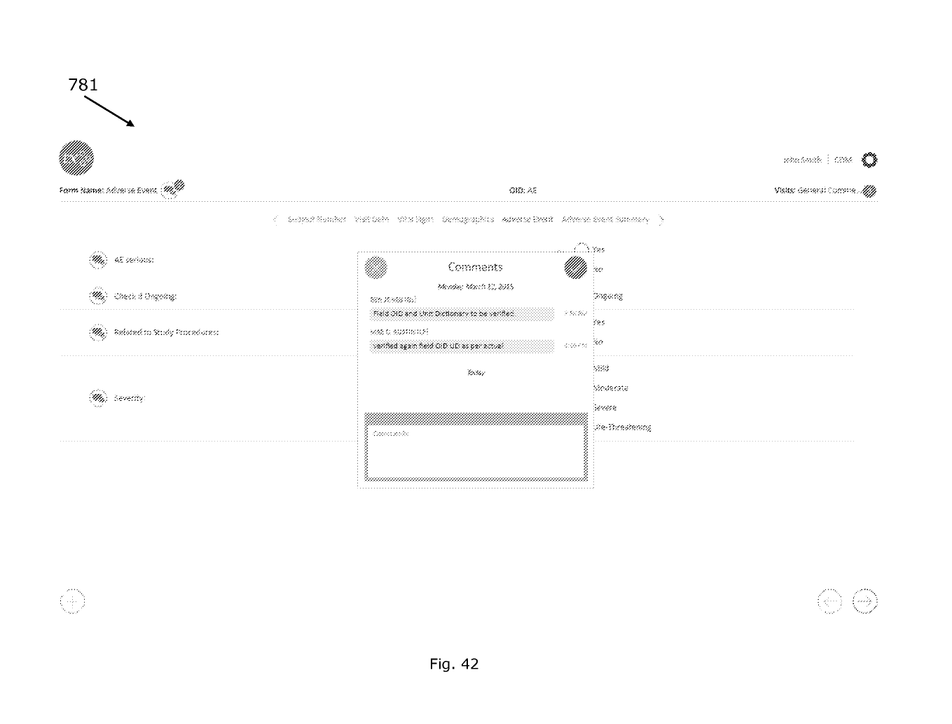

A comments screen 781 is shown in FIG. 42. The comments screen 741 allows all users to enter comments relating to any aspect of a build of a clinical study. Preferably, the server makes the comments screen 781 accessible from nearly every other screen that may be viewed in association with the clinical study, particularly elements such as forms, form fields, edit checks, and visits. The comments screen 781 helps track comments and provides a place for discussion to all users participating in building a particular clinical study, so that the users may collaborate to share their input, suggestions, and queries through the server.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A system for managing a clinical trial, the system comprising:
a server including a programmable processor, a memory, and a non-volatile storage device, the server programmed for establishing and maintaining a database for clinical trial management and for sending data from and receiving data into the database, wherein:
establishing the database includes accessing form data, defining from the form data a plurality of forms and a plurality of form fields associated with the plurality of forms, defining a clinical trial structure from the form data, and defining database fields from the form data;
a plurality of remote programmable devices, each remote programmable device being configured to communicate with the server over a network, wherein:
at least a first of the plurality of remote programmable devices is programmed to direct the server to access the form data, the form data including form correlation data, from which the server defines associations between the plurality of form fields and the plurality of forms within the database, and a plurality of form use identifiers, from which the server defines the clinical trial structure;
at least a second of the plurality of remote programmable devices is programmed to send to the server information about patients participating in the clinical trial, the server assigning a patient identifier to each patient; and
at least a third of the plurality of remote programmable devices is programmed to communicate to the server the patient identifier for a first of the patients, receive from the server, in response to the patient identifier, a first subset of the plurality of forms, receiving an input of trial data into one or more of the form fields associated with the first subset of the plurality of forms, and communicating the trial data to the server for incorporation into the database.

2. The system of claim 1, wherein maintaining the database includes receiving from, at least one of the plurality of remote programmable devices, revised form data indicating a change to one or more of the plurality of forms, and changing at least one of the clinical trial structure and the database fields in response to the revised form data.

3. The system of claim 1, wherein at least one of the plurality of remote programmable devices is programmed to receive from the server a second subset of the plurality of forms, the second subset of the plurality of forms including one or more of the following: at least a portion of the trial data, validation information based on the trial data, and analysis information based on the trial data, the server being programmed to compile the validation information and the analysis information.

4. The system of claim 1, wherein the clinical trial structure includes a clinical trial schedule, and the form data indicates a predetermined usage for each of the plurality of forms within the clinical trial schedule.

5. The system of claim 4, wherein the first subset of the plurality of forms are received from the server, in response to the patient identifier, based upon a correspondence between a patient visit time and the predetermined usage for each of the first subset of plurality of forms within the clinical trial schedule.

6. The system of claim 1, wherein at least one of the plurality of remote programmable devices is programmed to present a graphical user interface to a user, the graphical user interface being configured for the user to identify a first form to be used as one of the plurality of forms, and wherein the form data sent to the server includes the identification of the first form.

7. The system of claim 1, wherein at least one of the plurality of remote programmable devices is programmed to instruct the server to incorporate a preexisting form into the form data.

8. A system for managing a clinical trial, the system comprising:
a server including a programmable processor, a memory, and a non-volatile storage device, the server configured to communicate over a network with a plurality of remote programmable devices and programmed for:
establishing a database for clinical trial management by receiving form data from at least a first of the plurality of remote programmable devices, defining from the form data a plurality of forms and a plurality of form fields associated with the plurality of forms, with associations between the plurality of forms and the plurality of form fields being determined by correlation data included in the form data, defining a clinical trial structure from a plurality of form use identifiers included in the form data, defining database fields from the form data, and from the database fields, defining the database;
receiving from at least a second of the plurality of remote programmable devices information about patients participating in the clinical trial and assigning a patient identifier to each patient; and
receiving from at least a third of the plurality of remote programmable devices the patient identifier for a first of the patients, sending to the third of the plurality of remote programmable devices, in response to receiving the patient identifier, a first subset of the plurality of forms, and receiving for incorporation into the database trial data input into one or more of the form fields associated with the first subset of the plurality of forms on the third of the plurality of remote programmable devices.

9. The system of claim 8, wherein the server is further programmed for receiving from at least one of the plurality of remote programmable devices revised form data indicating a change to one or more of the plurality of forms, and changing at least one of the clinical trial structure and the database fields in response to the revised form data.

10. The system of claim 8, wherein the server is further programmed for compiling validation information based on the trial data and analysis information based on the trial data and sending to at least one of the plurality of remote programmable devices a second subset of the plurality of forms, the second subset of the plurality of forms including one or more of the following: at least a portion of the trial data, the validation information, and the analysis information.

11. The system of claim 8, wherein the clinical trial structure includes a clinical trial schedule, and the form data indicates a predetermined usage for each of the plurality of forms within the clinical trial schedule.

12. The system of claim 11, wherein the first subset of the plurality of forms are sent by the server, in response to the received patient identifier, based upon a correspondence between a patient visit time and the predetermined usage for each of the first subset of plurality of forms within the clinical trial schedule.

13. The system of claim 8, wherein the form data received by the server includes an indication of a preexisting form to be incorporated into the form data.

14. A method for managing a clinical trial using a server including a programmable processor, a memory, and a non-volatile storage device, the server configured to communicate over a network with a plurality of remote programmable devices, the method comprising:
establishing, with the server, a database for clinical trial management by receiving form data from at least a first of the plurality of remote programmable devices, defining from the form data a plurality of forms and a plurality of form fields associated with the plurality of forms, with associations between the plurality of forms and the plurality of form fields being determined by correlation data included in the form data, defining a clinical trial structure from a plurality of form use identifiers included in the form data, defining database fields from the form data, and from the database fields, defining the database;
receiving from at least a second of the plurality of remote programmable devices information about patients participating in the clinical trial and assigning a patient identifier to each patient; and
receiving from at least a third of the plurality of remote programmable devices the patient identifier for a first of the patients, sending to the third of the plurality of remote programmable devices, in response to receiving the patient identifier, a first subset of the plurality of forms, and receiving for incorporation into the database trial data input into one or more of the form fields associated with the first subset of the plurality of forms on the third of the plurality of remote programmable devices.

15. The method of claim 14, further comprising receiving, by the server from at least one of the plurality of remote programmable devices, revised form data indicating a change to one or more of the plurality of forms, and changing at least one of the clinical trial structure and the database fields in response to the revised form data.

16. The method of claim 14, further comprising compiling, by the server, validation information based on the trial data and analysis information based on the trial data and sending to at least one of the plurality of remote programmable devices a second subset of the plurality of forms, the second subset of the plurality of forms including one or more of the following: at least a portion of the trial data, the validation information, and the analysis information.

17. The method of claim 14, wherein the clinical trial structure includes a clinical trial schedule, and the form data indicates a predetermined usage for each of the plurality of forms within the clinical trial schedule.

18. The method of claim 17, wherein sending, by the server, the first subset of the plurality of forms, in response to the received patient identifier, is based upon a correspondence between a patient visit time and the predetermined usage for each of the first subset of plurality of forms within the clinical trial schedule.

19. The method of claim 14, wherein receiving the form data by the server includes receiving an indication of a preexisting form to be incorporated into the form data.
